(19) United States
(12) Patent Application Publication
(10) Pub. No.: US 2017/0085096 A1
(43) Pub. Date: Mar. 23, 2017

(54) WIRELESS CHARGING RECEIVER USING PIEZOELECTRIC MATERIAL

(71) Applicant: QUALCOMM Incorporated, San Diego, CA (US)

(72) Inventors: John Hyunchul Hong, San Clemente, CA (US); Bing Wen, Poway, CA (US); Edward Keat Leem Chan, San Diego, CA (US); Tallis Young Chang, San Diego, CA (US); Zhigang Zhou, San Ramon, CA (US); Yaoling Pan, San Diego, CA (US)

(21) Appl. No.: 14/863,009

(22) Filed: Sep. 23, 2015

(51) Int. Cl. H02J 5/00; H02J 50/12; H02J 7/02

(52) U.S. Cl. CPC H02J 5/005; H02J 7/025; H02J 50/12

(57) ABSTRACT

This disclosure provides methods and apparatus for wireless power transfer using an array of structures. Each of the structures can include a piezoelectric material portion and a magnetic material portion. Each of the magnetic material portions can respond to an alternating magnetic field generated by an external transmitter device, resulting in the structures oscillating and straining the corresponding piezoelectric material portions to generate electrical current.

### FIELD

The present disclosure relates generally to electromechanical systems and devices, and more specifically, to a wireless charging receiver using piezoelectric material.

### BACKGROUND

An increasing number and variety of electronic devices are powered via rechargeable batteries. Such devices include mobile phones, portable music players, laptop computers, tablet computers, computer peripheral devices, communication devices (e.g., Bluetooth devices), digital cameras, hearing aids, and the like. While battery technology has improved, battery-powered electronic devices increasingly require and consume greater amounts of power, thereby often requiring recharging. Rechargeable devices are often charged via wired connections through cables or other similar connectors that are physically connected to a power supply. Cables and similar connectors may sometimes be inconvenient or cumbersome and have other drawbacks. Wireless charging systems that are capable of transferring power in free space to be used to charge rechargeable electronic devices or provide power to electronic devices may overcome some of the deficiencies of wired charging solutions. As such, methods and apparatuses for wireless power transmission are desirable.

### SUMMARY

Various implementations of systems, methods and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

One innovative aspect of the subject matter in this disclosure can be implemented in an apparatus for wireless power transfer comprising an array of structures, each of the structures comprising a piezoelectric material portion and a magnetic material portion, each of the magnetic material portions capable of responding to an alternating magnetic field generated by an external transmitter device to oscillate the corresponding structures and strain the corresponding piezoelectric material portions to generate electrical current.

In some implementations, the array can include a first structure including a first magnetic material portion and a second structure including a second magnetic material portion, the first magnetic material portion and the second magnetic material portion having a same magnetic orientation.

In some implementations, the array can include a first structure including a first magnetic material portion having a first magnetic orientation and a second structure including a second magnetic material portion having a second magnetic orientation, the first magnetic orientation and the second magnetic orientation being different orientations.

In some implementations, the first structure and the second structure can be capable of oscillating at different phases.

In some implementations, the array of structures can include a first structure having the magnetic material portion positioned at a location on the first structure capable of depressing into free space beneath the first structure based on the magnetic material portion reacting to the alternating magnetic field.

In some implementations, the first structure can be affixed to a substrate, the substrate defines a cavity underneath the magnetic material portion of the first structure, and wherein a bottom surface of the cavity is beneath a top surface of the substrate.

In some implementations, the array of structures can include a first structure having a plate affixed with the magnetic material portion, and the plate is capable of being deformed into a cavity of a substrate beneath the plate.

In some implementations, the plate of the first structure can be anchored on one or more hinges of the first structure, the one or more hinges including the piezoelectric material portions.

In some implementations, the apparatus can comprise power extraction circuitry capable of receiving the generated electrical current from each of the structures of the array.

In some implementations, the power extraction circuitry can be further capable of rectifying the generated electrical currents from each of the structures of the array and providing a direct current (DC) power source to a load.

In some implementations, the power extraction circuitry can be further capable of adjusting a resonant frequency of the oscillation of one or more of the structures.

In some implementations, the power extraction circuitry can be further capable of adjusting the resonant frequency of the one or more of the structures by generating a voltage to be applied to the piezoelectric material portions of one or more of the structures.

In some implementations, rigidities of the piezoelectric material portions can be adjusted based on the voltage applied to the piezoelectric material portions of the one or more of the structures.

In some implementations, magnetic orientations of the magnetic material portions of the structures can be substantially parallel to a substrate that the structures are affixed to.

In some implementations, each of the structures can be capable of oscillating to a resonant frequency that is substantially the same as a frequency of the alternating magnetic field.

In some implementations, each of the structures can be a mechanically resonant structure configured to oscillate at a resonant frequency.

Another innovative aspect of the subject matter described in this disclosure can be implemented in a system for wireless power transfer comprising a first structure having a first piezoelectric material deposit and a first magnetic material deposit; a second structure having a second piezoelectric material deposit and a second magnetic material deposit, wherein the first and second magnetic material deposits are capable of responding to an alternating magnetic field generated by an external transmitter device to oscillate the corresponding structures and strain the corresponding piezoelectric material deposits to generate electrical current; and power circuitry capable of receiving the electrical current from the first structure and the second structure, and further capable of providing a power supply based on the received electrical current.

In some implementations, the first magnetic material deposit and the second magnetic material deposit can have a same magnetic orientation.

In some implementations, the first magnetic material deposit can have a first magnetic orientation and the second magnetic material deposit can have a second magnetic orientation, the first magnetic orientation and the second magnetic orientation being different orientations.

Another innovative aspect of the subject matter described in this disclosure can be implemented in a method for wireless power transfer comprising oscillating structures in an array of structures in response to an alternating magnetic field, each of the structures oscillating based on a response of a corresponding magnetic material of the structures to the alternating magnetic field; and deforming a piezoelectric material on the structures of the array to generate electrical current.

In some implementations, the method comprises adjusting a resonant frequency of the oscillation of a first structure in the array in response to the generated electrical current of a second structure in the array.

Another innovative aspect of the subject matter described in this disclosure can be implemented in an array of structures for wireless power transfer, each of the structures comprising means for responding to an alternating magnetic field to generate mechanical energy; and means for converting the mechanical energy to electrical energy.

In some implementations, the alternating magnetic field can be generated by an external transmitter device.

In some implementations, each of the structures can oscillate in response to the alternating magnetic field.

In some implementations, the array comprises means for adjusting a resonant frequency of oscillation of one or more of the structures of the array.

In some implementations, the array comprises means for generating electrical currents from each of the structures.

In some implementations, the array comprises means for rectifying the electrical currents generated from each of the structures of the array.

In some implementations, the array comprises means for providing a direct current (DC) power source using the rectified electrical currents to power a load.

In some implementations, the array can include a first structure including a first magnetic material portion having a first magnetic orientation and a second structure including a second magnetic material portion having a second magnetic orientation, the first magnetic orientation and the second magnetic orientation being different orientations.

In some implementations, the first structure and the second structure can be capable of oscillating at different phases.

### BRIEF DESCRIPTION OF THE DRAWINGS

FIG. 1 is a functional block diagram of a wireless power transfer system, in accordance with some exemplary implementations.

FIG. 2 is a functional block diagram of components that may be used in the wireless power transfer system of FIG. 1, in accordance with some exemplary implementations.

FIG. 3 is a schematic diagram of a portion of transmit circuitry or receive circuitry of FIG. 2 including a transmit or receive coupler.

FIG. 4 is a functional block diagram of a transmitter that may be used in the wireless power transfer system of FIG. 1, in accordance with some exemplary implementations.

FIG. 5 is a functional block diagram of a receiver that may be used in the wireless power transfer system of FIG. 1, in accordance with some exemplary implementations.

FIG. 6 is a schematic diagram of a portion of transmit circuitry that may be used in the transmitter of FIG. 4.

FIG. 7 illustrates non-radiative inductive power transfer based on Faraday's law using capacitively loaded wire loops at both the transmit and receive sides.

FIG. 8 schematically illustrates an example magneto-mechanical oscillator, in accordance with some exemplary implementations.

FIG. 9 schematically illustrates an example magneto-mechanical oscillator (e.g., a portion of a plurality of magneto-mechanical oscillators) with a coupling coil wound around (e.g., surrounding) the magneto-mechanical oscillator, in accordance with some exemplary implementations.

FIG. 10A schematically illustrates the parallel magnetic flux lines (B) inside a magnetized sphere.

FIG. 10B schematically illustrates the magnetic field strength (H) in a magnetized sphere.

FIG. 11 schematically illustrates an example array of magneto-mechanical oscillators, in accordance with some exemplary implementations.

FIG. 12 schematically illustrates a cut through area of a three-dimensional array of magneto-mechanical oscillators, in accordance with some exemplary implementations.

FIG. 13 schematically illustrates an example coupling coil wound around a disk having a plurality of magneto-mechanical oscillators, in accordance with some exemplary implementations.

FIG. 14 schematically illustrates an example power transmitter configured to wirelessly transfer power to at least one power receiver, in accordance with some exemplary implementations.

FIG. 15 schematically illustrates an example power transmitter, in accordance with some exemplary implementations, and a plot of input impedance versus frequency showing a resonance phenomenon.

FIG. 16 schematically illustrates a portion of a configuration of a plurality of magneto-mechanical oscillators, in accordance with some exemplary implementations.

FIG. 17 schematically illustrates a configuration of the plurality of magneto-mechanical oscillators in which magnetic elements are pairwise oriented in opposite directions so that the static component of the sum magnetic moment cancels out, in accordance with some exemplary implementations.

FIG. 18A illustrates a cantilever including piezoelectric material and magnetic material, in accordance with some exemplary implementations.

FIG. 18B illustrates a top-down perspective of the cantilever of FIG. 18A, in accordance with some exemplary implementations.

FIG. 19A illustrates an array of cantilevers with uniform magnetic orientations, in accordance with some exemplary implementations.

FIG. 19B illustrates an array of cantilevers with non-uniform magnetic orientations, in accordance with some exemplary implementations.

FIG. 20 schematically illustrates power extraction circuitry coupled to cantilevers to power a load, in accordance with some exemplary implementations.

FIG. 21 illustrates two cantilevers responding differently to a magnetic field, in accordance with some exemplary implementations.

FIG. 22 schematically illustrates power extraction circuitry to adjust a resonant frequency of cantilevers, in accordance with some exemplary implementations.

FIG. 23A illustrates a beam including piezoelectric material and magnetic material, in accordance with some exemplary implementations.

FIG. 23B illustrates a top-down perspective of the cantilever of FIG. 23A, in accordance with some exemplary implementations.

FIG. 24 illustrates a torsional plate including piezoelectric material and magnetic material, in accordance with some exemplary implementations.

FIG. 25A illustrates a magnetic structure with a center of rotation within the magnetic structure, in accordance with some exemplary implementations.

FIG. 25B illustrates an array of magnetic structures with centers of rotation within the magnetic structures, in accordance with some implementations.

FIG. 26 is a flowchart of a method of using a receiver of a wireless charging system, in accordance with some exemplary implementations.

FIG. 27 is a flowchart of a method of using an array of structures including piezoelectric material as a power supply, in accordance with some exemplary implementations.

The various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

Piezoelectric material can be stretched or contracted, resulting in a voltage generated across it, and therefore, charge and/or current may be generated and used to power a load.

Some implementations of the subject matter described in this disclosure implement a transducer to convert a magnetic field to mechanical energy and the mechanical energy to electrical energy with the use of piezoelectric material. For example, a magneto-mechanical oscillator structure can include magnetic material and piezoelectric material. The piezoelectric material can be on a hinge or other type of support allowing for the movement of magnetic material in a free space. The magnetic material can move by oscillating in response to an externally applied magnetic field (e.g., provided by a transmitter of a wireless power transmission system), resulting in the stretching and contracting of the piezoelectric material during the oscillations, and therefore, provide an electrical current used by a receiver for the wireless power transmission system to power a load. The magneto-mechanical oscillator can be part of an array of magneto-mechanical oscillators that can be configured to mechanically resonate in response to a magnetic field with a particular frequency. As a result, the array can convert the magnetic field to mechanical energy and the mechanical energy to electrical energy.

Particular implementations of the subject matter described in this disclosure can be implemented to realize one or more of the following potential advantages. Implementing a wireless power transmission system with piezoelectric material can allow for a system to avoid the use of a coil (or multiple coils) surrounding the magneto-mechanical oscillators in a receiver to convert the externally applied magnetic field provided by a transmitter to mechanical energy (e.g., from the oscillation of the magneto-mechanical oscillators) and the mechanical energy to electrical energy (e.g., by the inducement of current in the coil) that can be used to power a load. This may allow for a receiver of the wireless power transmission system to occupy less space. In some implementations, the magneto-mechanical oscillators can also operate with a lower quality factor.

The detailed description set forth below in connection with the appended drawings is intended as a description of exemplary implementations of the invention and is not intended to represent the only implementations in which the invention may be practiced. The term “exemplary” used throughout this description means “serving as an example, instance, or illustration,” and should not necessarily be construed as preferred or advantageous over other exemplary implementations. The detailed description includes specific details for the purpose of providing a thorough understanding of the exemplary implementations of the invention. In some instances, some devices are shown in block diagram form.

Wirelessly transferring power may refer to transferring any form of energy associated with electric fields, magnetic fields, electromagnetic fields, or otherwise from a transmitter to a receiver without the use of physical electrical conductors (e.g., power may be transferred through free space). The power output into a wireless field (e.g., a magnetic field) may be received, captured by, or coupled by a receiver to achieve power transfer.

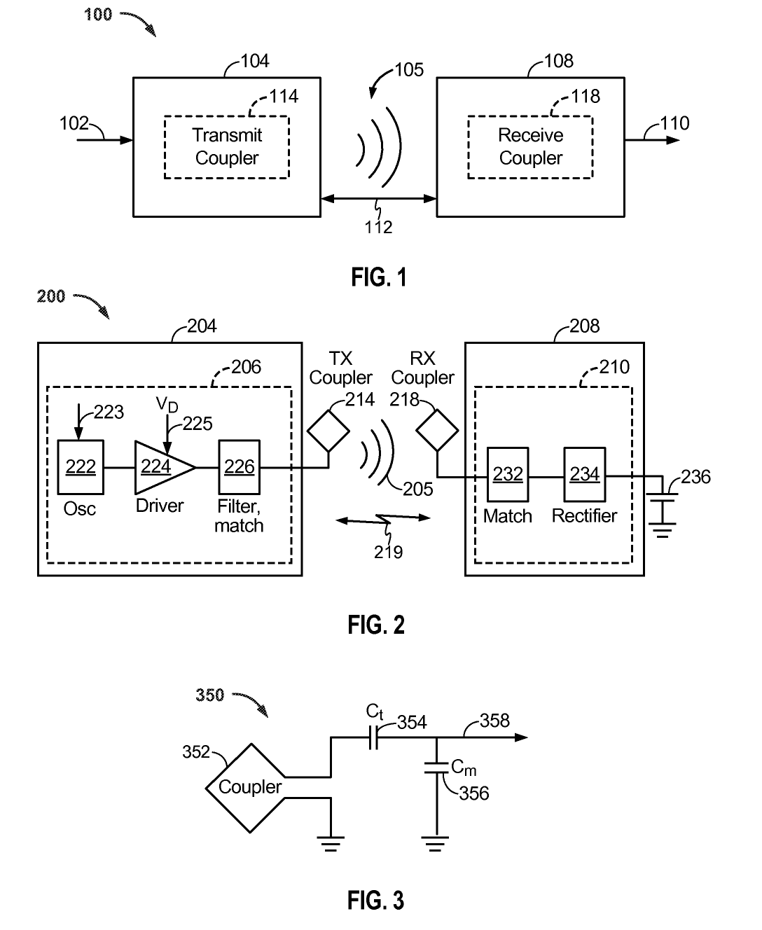

FIG. 1 is a functional block diagram of a wireless power transfer system 100, in accordance with some exemplary implementations. Input power 102 may be provided to a transmitter 104 from a power source (not shown) to generate a wireless (e.g., magnetic or electromagnetic) field 105 via a transmit coupler 114 for performing energy transfer. The receiver 108 may receive power when the receiver 108 is located in the wireless field 105 produced by the transmitter 104. The wireless field 105 corresponds to a region where energy output by the transmitter 104 may be captured by the receiver 108. A receiver 108 including a receive coupler 118 may couple to the wireless field 105 and generate output power 110 for storing or consumption by a device (not shown in this figure) coupled to the output power 110. Both the transmitter 104 and the receiver 108 are separated by a distance 112.

In one example implementation, power is transferred inductively via a time-varying magnetic field generated by the transmit coupler 114. The transmitter 104 and the receiver 108 may further be configured according to a mutual resonant relationship. When the resonant frequency of the receiver 108 and the resonant frequency of the transmitter 104 are substantially the same or very close, transmission losses between the transmitter 104 and the receiver 108 are reduced. However, even when resonance between the transmitter 104 and receiver 108 are not matched, energy may be transferred, although the efficiency may be reduced. For example, the efficiency may be less when resonance is not matched. Transfer of energy occurs by coupling energy from the wireless field 105 of the transmit coupler 114 to the receive coupler 118, residing in the vicinity of the wireless field 105, rather than propagating the energy from the transmit coupler 114 into free space.

Resonant coupling techniques may thus allow for improved efficiency and power transfer over various distances and with a variety of magneto-mechanical oscillator coupler configurations.

The receiver 108 may receive power when the receiver 108 is located in the wireless field 105 produced by the transmitter 104. The wireless field 105 corresponds to a region where energy output by the transmitter 104 may be captured by the receiver 108. The wireless field 105 may correspond to the “near-field” of the transmitter 104. The near-field may correspond to a region in which there are strong reactive fields resulting from the magnetic and/or electromagnetic fields generated by the transmit coupler 114 that minimally radiate power away from the transmit coupler 114. The near-field may correspond to a region that is within about one wavelength (or a fraction thereof) of the fundamental frequency at which the transmit coupler 114 operates.

FIG. 2 is a functional block diagram of a wireless power transfer system 200, in accordance with some other exemplary implementations. The system 200 may be a wireless power transfer system of similar operation and functionality as the system 100 of FIG. 1. However, the system 200 provides additional details regarding the components of the wireless power transfer system 200 as compared to FIG. 1. The system 200 includes a transmitter 204 and a receiver 208. The transmitter 204 includes transmit circuitry 206 that includes an oscillator 222, a driver circuit 224, and a filter and matching circuit 226. The oscillator 222 may be configured to generate a signal at a desired frequency that may be adjusted in response to a frequency control signal 223. The oscillator 222 provides the oscillator signal to the driver circuit 224. The driver circuit 224 may be configured to drive the transmit coupler 214 at a resonant frequency of the transmit coupler 214 based on an input voltage signal (V_{D}) 225.

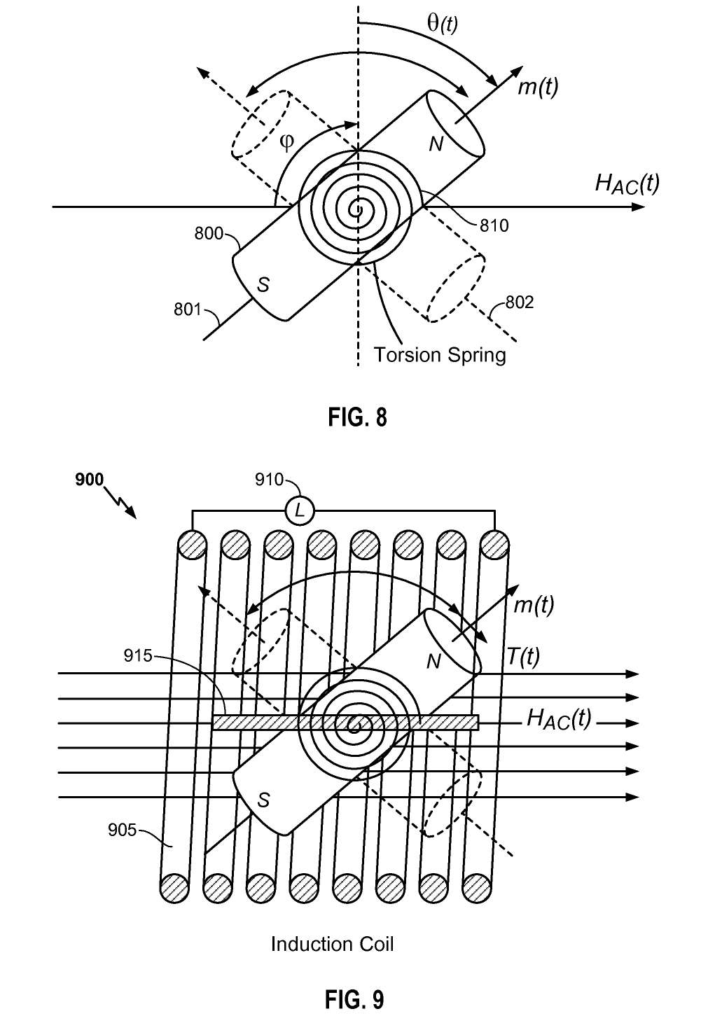

The filter and matching circuit 226 filters out harmonics or other unwanted frequencies and matches the impedance of the transmit circuitry 206 to the impedance of the transmit coupler 214. As a result of driving the transmit coupler 214, the transmit coupler 214 generates a wireless field 205 to wirelessly output power at a level sufficient for charging a battery 236. As will be described in more detail in connection with FIGS. 8-27 below, the transmit coupler 214 may be configured to excite one or more (e.g., a 2-dimensional or 3-dimensional array of) magneto-mechanical oscillators (not shown in FIG. 2) to physically oscillate about at least one rotation axis in resonance with the wireless field 205. The physical resonant oscillation of the oscillators may reinforce the wireless field 205, increasing its strength.

The receiver 208 comprises receive circuitry 210 that includes a matching circuit 232 and a rectifier circuit 234. The matching circuit 232 may match the impedance of the receive circuitry 210 to the impedance of the receive coupler 218. The rectifier circuit 234 may generate a direct current (DC) power output from an alternate current (AC) power input to charge the battery 236. The receiver 208 and the transmitter 204 may additionally communicate on a separate communication channel 219 (e.g., Bluetooth, Zigbee, cellular, etc.). The receiver 208 and the transmitter 204 may alternatively communicate via in-band signaling using characteristics of the wireless field 205. In some implementations, the receiver 208 may be configured to determine whether an amount of power transmitted by the transmitter 204 and received by the receiver 208 is appropriate for charging the battery 236.

FIG. 3 is a schematic diagram of a portion of the transmit circuitry 206 or the receive circuitry 210 of FIG. 2. As illustrated in FIG. 3, transmit or receive circuitry 350 may include a coupler 352. The coupler 352 may also be referred to or be configured as a “conductor loop”, a coil, an antenna, an inductor, or a “magnetic” coupler. The term “coupler” generally refers to a component that may wirelessly output or receive energy for coupling to another “coupler.”

The resonant frequency of the loop or magnetic couplers is based on the inductance and capacitance of the loop or magnetic coupler. Inductance may be simply the inductance created by the coupler 352, whereas, capacitance may be added via a capacitor (or the self-capacitance of the coupler 352) to create a resonant structure at a desired resonant frequency. As a non-limiting example, a capacitor 354 and a capacitor 356 may be added to the transmit or receive circuitry 350 to create a resonant circuit configured to resonate at a resonant frequency. For larger sized couplers using large diameter couplers exhibiting larger inductance, the value of capacitance needed to produce resonance may be lower. Furthermore, as the size of the coupler increases, coupling efficiency may increase. This is mainly true if the size of both transmit and receive couplers increase. For transmit couplers, the signal 358, with a frequency that substantially corresponds to the resonant frequency of the coupler 352, may be an input to the coupler 352. For receive couplers, the signal 358 may be output to charge or power a load.

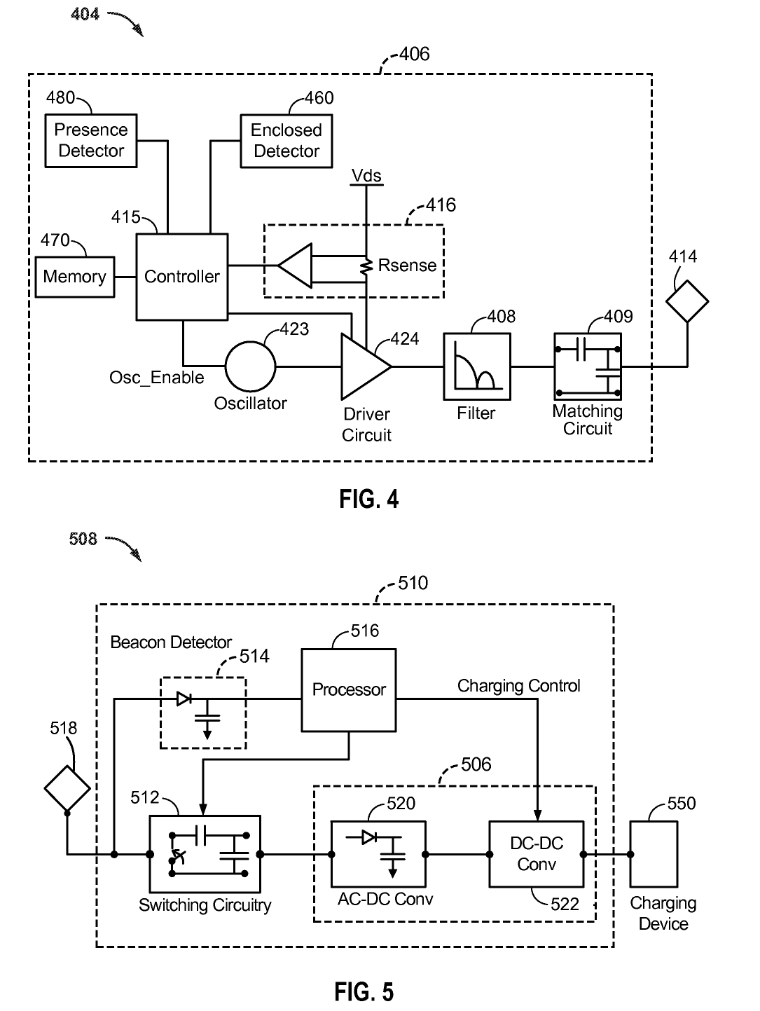

FIG. 4 is a functional block diagram of a transmitter 404 that may be used in the wireless power transfer system of FIG. 1, in accordance with some exemplary implementations of the invention. The transmitter 404 may include transmit circuitry 406 and a transmit coupler 414. The transmit coupler 414 may be the coupler 352 as shown in FIG. 3. Transmit circuitry 406 may provide power to the transmit coupler 414 by providing an oscillating signal resulting in generation of energy (e.g., magnetic flux) about the transmit coupler 414. Transmitter 404 may operate at any suitable frequency.

Transmit circuitry 406 may include a fixed impedance matching circuit 409 for matching the impedance of the transmit circuitry 406 (e.g., 50 ohms) to the impedance of the transmit coupler 414 and a low pass filter (LPF) 408 configured to reduce harmonic emissions to levels to prevent self-jamming of devices coupled to a receiver 108 (FIG. 1). Other exemplary implementations may include different filter topologies, including but not limited to, notch filters that attenuate specific frequencies while passing others and may include an adaptive impedance match, that may be varied based on measurable transmit metrics, such as output power to the coupler 414 or DC current drawn by the driver circuit 424. Transmit circuitry 406 further includes a driver circuit 424 configured to drive a signal as determined by an oscillator 423. The transmit circuitry 406 may be comprised of discrete devices or circuits, or alternately, may be comprised of an integrated assembly. An exemplary power output from the transmit coupler 414 may be on the order of anywhere from 0.5 Watts, to 1 Watt, to 2.5 Watts, to 50 Watts and the like. Higher or lower power levels are also contemplated. For example, if aspects described herein are implemented on a scale for charging a load such as an electric vehicle, power output may be on the order of kilowatts.

Transmit circuitry 406 may further include a controller 415 for selectively enabling the oscillator 423 during transmit phases (or duty cycles) for specific receivers, for adjusting the frequency or phase of the oscillator 423, and for adjusting the output power level for implementing a communication protocol for interacting with neighboring devices through their attached receivers. It is noted that the controller 415 may also be referred to herein as a processor. The controller 415 may be coupled to a memory 470, for example for storing instructions that may be executed by controller 415 or storing other information related to the power transfer. Adjustment of oscillator phase and related circuitry in the transmission path may allow for reduction of out of band emissions, especially when transitioning from one frequency to another.

The transmit circuitry 406 may further include a load sensing circuit 416 for detecting the presence or absence of active receivers in the vicinity of the near-field generated by transmit coupler 414. By way of example, a load sensing circuit 416 monitors the current flowing to the driver circuit 424, that may be affected by the presence or absence of active receivers in the vicinity of the field generated by transmit coupler 414 as will be further described below. Detection of changes to the loading on the driver circuit 424 are monitored by controller 415 for use in determining whether to enable the oscillator 423 for transmitting energy and to communicate with an active receiver. As described more fully below, a current measured at the driver circuit 424 may be used to determine whether an invalid device is positioned within a wireless power transfer region of the transmitter 404.

The transmit coupler 414 may include a component including Litz wire or as an coupler strip with the thickness, width and metal type selected to keep resistive losses low. In a one implementation, the transmit coupler 414 may generally be configured for association with a larger structure such as a table, mat, lamp or other less portable configuration. A transmit coupler may also use a system of magneto-mechanical oscillators in accordance with some exemplary implementations described herein.

The transmitter 404 may gather and track information about the whereabouts and status of receiver devices that may be associated with the transmitter 404. Thus, the transmit circuitry 406 may include a presence detector 480, an enclosed detector 460, or a combination thereof, connected to the controller 415 (also referred to as a processor herein). The controller 415 may adjust an amount of power delivered by the driver circuit 424 in response to presence signals from the presence detector 480 and the enclosed detector 460. The transmitter 404 may receive power through a number of power sources, such as, for example, an AC-DC converter (not shown) to convert AC power present in a building, a DC-DC converter (not shown) to convert a DC power source to a voltage suitable for the transmitter 404, or directly from a DC power source (not shown).

FIG. 5 is a functional block diagram of a receiver 508 that may be used in the wireless power transfer system of FIG. 1, in accordance with some exemplary implementations of the invention. The receiver 508 includes receive circuitry 510 that may include a receive coupler 518. Receiver 508 further couples to device 550 for providing received power thereto. It should be noted that receiver 508 is illustrated as being external to device 550 but may be integrated into device 550. Energy may be propagated wirelessly to receive coupler 518 and then coupled through the rest of the receive circuitry 510 to device 550. By way of example, the charging device may include devices such as mobile phones, vehicles, portable music players, laptop computers, tablet computers, computer peripheral devices, communication devices (e.g., Bluetooth devices), digital cameras, hearing aids (and other medical devices), and the like.

Receive coupler 518 may be tuned to resonate at the same frequency, or within a specified range of frequencies, as transmit coupler 414 (FIG. 4). Receive coupler 518 may be similarly dimensioned with transmit coupler 414 or may be differently sized based upon the dimensions of the associated device 550. By way of example, device 550 may be a portable electronic device having diametric or length dimension smaller than the diameter or length of transmit coupler 414.

Receive circuitry 510 may provide an impedance match to the receive coupler 518. Receive circuitry 510 includes power conversion circuitry 506 for converting received energy into charging power for use by the device 550. Power conversion circuitry 506 includes an AC-to-DC converter 520 and may also include a DC-to-DC converter 522. AC-to-DC converter 520 rectifies the AC energy signal received at receive coupler 518 into a non-alternating power with an output voltage represented by V_{rect}. The DC-to-DC converter 522 (or other power regulator) converts the rectified AC energy signal into an energy potential (e.g., voltage) that is compatible with device 550 with an output voltage and output current. Various AC-to-DC converters are contemplated, including partial and full rectifiers, regulators, bridges, doublers, as well as linear and switching converters.

Receive circuitry 510 may further include switching circuitry 512 for connecting receive coupler 518 to the power conversion circuitry 506 or alternatively for disconnecting the power conversion circuitry 506. Disconnecting receive coupler 518 from power conversion circuitry 506 not only suspends charging of device 550, but also changes the “load” as “seen” by the transmitter 404 (FIG. 2).

In some exemplary implementations, communication between the transmitter 404 and the receiver 508 refers to a device sensing and charging control mechanism. In other words, the transmitter 404 may use on/off keying of the transmitted signal to adjust whether energy is available in the near-field. The receiver may interpret these changes in energy as a message from the transmitter 404. From the receiver side, the receiver 508 may use tuning and de-tuning of the receive coupler 518 to adjust how much power is being accepted from the field. In some cases, the tuning and de-tuning may be accomplished via the switching circuitry 512. The transmitter 404 may detect this difference in power used from the field and interpret these changes as a message from the receiver 508. It is noted that other forms of modulation of the transmit power and the load behavior may be utilized.

Receive circuitry 510 may further include signaling detector and beacon circuitry 514 used to identify received energy fluctuations that may correspond to informational signaling from the transmitter to the receiver. Furthermore, signaling and beacon circuitry 514 may also be used to detect the transmission of a reduced signal energy (i.e., a beacon signal) and to rectify the reduced signal energy into a nominal power for awakening either un-powered or power-depleted circuits within receive circuitry 510 in order to configure receive circuitry 510 for wireless charging.

Receive circuitry 510 further includes processor 516 for coordinating the processes of receiver 508 described herein including the control of switching circuitry 512 described herein. Processor 516 may monitor beacon circuitry 514 to determine a beacon state and extract messages sent from the transmitter 404. Processor 516 may also adjust the DC-to-DC converter 522 for improved performance.

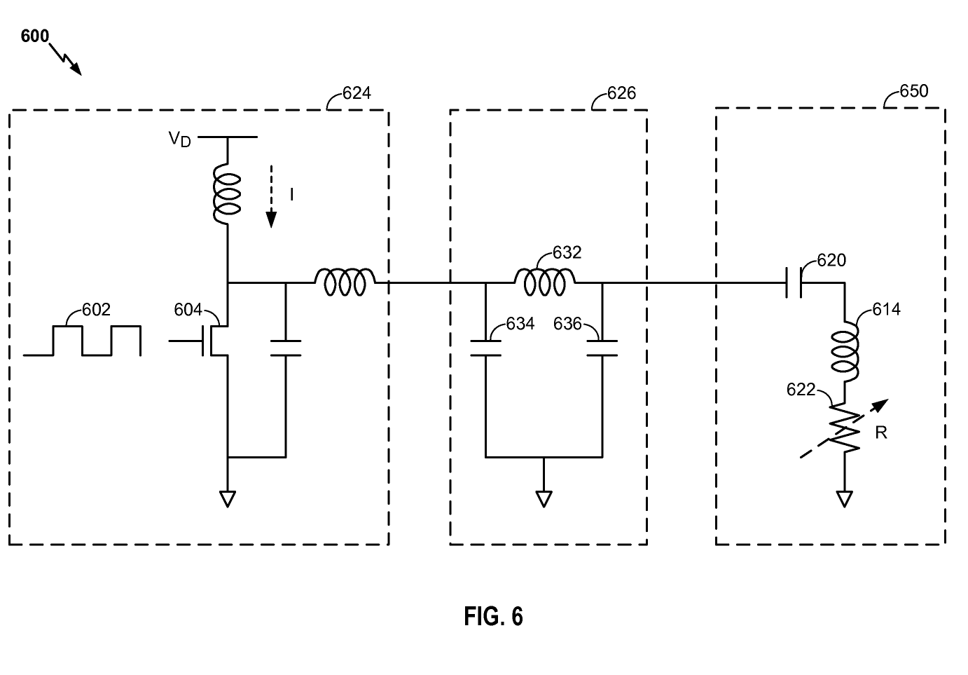

FIG. 6 is a schematic diagram of a portion of transmit circuitry 600 that may be used in the transmitter 404 of FIG. 4. The transmit circuitry 600 may include a driver circuit 624 as described above in FIG. 4. The driver circuit 624 may be a switching amplifier that may be configured to receive a square wave and output a sine wave to be provided to the transmit circuit 650. In some cases the driver circuit 624 may be referred to as an amplifier circuit. The driver circuit 624 may be driven by an input signal 602 from an oscillator 423 as shown in FIG. 4. The driver circuit 624 may also be provided with a drive voltage V_{D} that is configured to control the maximum power that may be delivered through a transmit circuit 650. To eliminate or reduce harmonics, the transmit circuitry 600 may include a filter circuit 626. The filter circuit 626 may be a three pole (capacitor 634, inductor 632, and capacitor 636) low pass filter circuit 626.

The signal output by the filter circuit 626 may be provided to a transmit circuit 650 comprising a coupler 614 and a capacitor 620 coupled in series with the coupler 614. The transmit circuit 650 may include a series resonant circuit that may resonate at a frequency of the filtered signal provided by the driver circuit 624. The load of the transmit circuit 650 may be represented by the variable resistor 622. The load may be a function of a receiver 508 that is positioned to receive power from the transmit circuit 650.

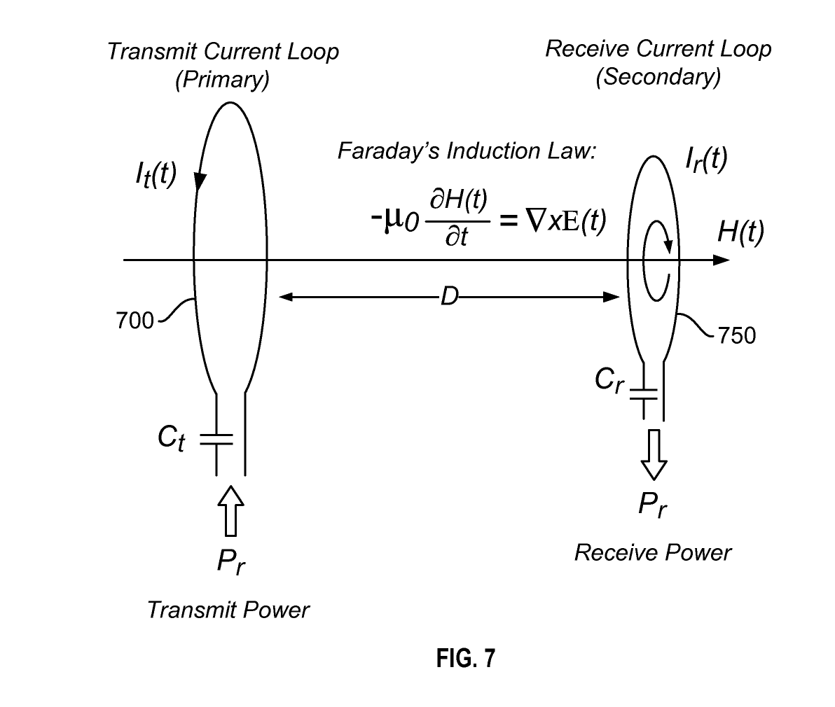

FIG. 7 illustrates non-radiative energy transfer that is based on Faraday's induction law, which may be expressed as:

$$- {μ}_{0} \frac{\partial H ( t )}{\partial t} = ∇ \times E ( t )$$

where ∇×E(t) denotes curl of the electric field generated by the alternating magnetic field. A transmitter forms a primary coupler (e.g., a transmit coupler as described above) and a receiver forms a secondary coupler (e.g., a receiver coupler as described above) separated by a transmission distance. The primary coupler represents the transmit coupler generating an alternating magnetic field. The secondary coupler represents the receive coupler that extracts electrical power from the alternating magnetic field using Faraday's induction law.

The generally weak coupling that exists between the primary coupler and secondary coupler may be considered as a stray inductance. This stray inductance, in turn, increases the reactance, which itself may hamper the energy transfer between primary coupler and secondary coupler. The transfer efficiency of this kind of weakly coupled system may be improved by using capacitors that are tuned to the precise opposite of the reactance at the operating frequency. When a system is tuned in this way, it becomes a compensated transformer which is resonant at its operating frequency. The power transfer efficiency is then only limited by losses in the primary coupler and secondary coupler. These losses are themselves defined by their quality or Q factors and the coupling factor between the primary coupler and the secondary coupler. Different tuning approaches may be used. Examples include, but are not limited to, compensation of the full reactance as seen at the primary coupler or secondary coupler (e.g., when either is open-circuited), and compensation of stray inductance. Compensation may also be considered as part of the source and load impedance matching in order to maximize the power transfer. Impedance matching in this way can hence increase the amount of power transfer.

As the distance D between the transmitter 700 and the receiver 750 increases, the efficiency of the transmission can decrease. At increased distances, larger loops, and/or larger Q factors may be used to improve the efficiency. However, when these devices are incorporated into a portable device, the size of the loop, thus its coupling and its Q-factor, may be limited by the parameters of the portable device.

Efficiency may be improved by reducing coupler losses. In general, losses may be attributed to imperfectly conducting materials, and eddy currents in the proximity of the loop. At lower frequencies (e.g., such as less than 1 MHz), flux magnification materials such as ferrite materials may be used to artificially increase the size of the coupler. Eddy current losses may inherently be reduced by concentrating the magnetic field. Special kinds of wire can also be used to lower the resistance, such as stranded or Litz wire at low frequencies to mitigate skin effect.

A species of resonant inductive energy transfer uses a magneto-mechanical system as described herein. The magneto-mechanical system may be part of an energy receiving system that picks up energy from an alternating magnetic field, converts it to mechanical energy, and then reconverts that mechanical energy into electrical energy using Faraday's induction law.

According to an implementation, the magneto-mechanical system is formed of a magnetic element, e.g. a permanent magnetic element, which is mounted in a way that allows it to oscillate under the force of an external alternating magnetic field. This transforms energy from the magnetic field into mechanical energy. In an implementation, this oscillation uses rotational moment around an axis perpendicular to the vector of the magnetic dipole moment m, and is also positioned in the center of gravity of the magnetic element. This allows equilibrium and thus minimizes the effect of the gravitational force. A magnetic field applied to this system produces a torque of T=μ₀ (m×H). This torque tends to align the magnetic dipole moment of the elementary magnetic element along the direction of the field vector. Assuming an alternating magnetic field, the torque accelerates the moving magnet(s), thereby transforming the oscillating magnetic energy into mechanical energy.

For example, in some implementations, a transmit coupler, e.g., as shown in any of FIGS. 1-4 and 7, may be utilized to generate a time-varying exciting magnetic field that may cause one or more first magneto-mechanical oscillators, as will be described below, to physically oscillate. Such physical oscillation of magnetic elements within the first oscillators may cause the first oscillators themselves to further generate a time-varying excited magnetic field at substantially the same frequency as the exciting magnetic field. In some implementations, this excited magnetic field may cause one or more second magneto-mechanical oscillators at a distance from the first oscillators to physically oscillate at the frequency of the excited magnetic field generated by the first oscillators, which in turn, causes magnetic elements within the second oscillators to generate an excited magnetic field at that frequency. A receive coupler, e.g., as shown in any of FIGS. 1-3, 5 and 7, located near or around the second oscillators may generate an alternating current under the influence of the excited magnetic field generated by the second oscillators. The operation of such systems will be described in more detail in connection with FIGS. 8-27 below.

FIG. 8 schematically illustrates an example magneto-mechanical oscillator, in accordance with some exemplary implementations. The magneto-mechanical oscillator of FIG. 8 comprises a magnetic element 800 having a magnetic moment m(t) (e.g., a vector having a constant magnitude but an angle that is time-varying, such as a magnetic dipole moment) and the magnetic element 800 is mechanically coupled to an underlying substrate (not shown) by at least one spring (e.g., a torsion spring 810). This spring holds the magnetic element in position shown as 801 when no torque from the magnetic field is applied. Magnetic torque causes the magnetic element 800 to move against the restoring force of the torsion spring 810, to the position 802, against the force of the spring with spring constant K_{R}. The magneto-mechanical oscillator may be considered a torsion pendulum with an inertial moment I and exhibiting a resonance at a frequency proportional to K_{R} and I. Frictional losses and in most cases a very weak electromagnetic radiation is caused by the oscillating magnetic moment. If this magneto-mechanical oscillator is subjected to an alternating field H_{AC}(t) with a frequency near the resonance frequency of the magneto-mechanical oscillator, then the magneto-mechanical oscillator will oscillate with an angular displacement θ(t) depending on the intensity of the applied magnetic field and reaching a maximum, peak displacement at resonance.

According to another implementation, some or all of the restoring force of the spring may be replaced by an additional static magnetic field H₀. This static magnetic field may be oriented to provide the torque T₀=μ₀(m×H₀). Another implementation may use both the spring and a static magnetic field to produce the restoring force of the magneto-mechanical oscillator. The mechanical energy is reconverted into electrical energy using Faraday induction, e.g. the dynamo principle. This may be used for example an induction coil 905 wound around the magneto-electrical system 900 as shown in FIG. 9. In another example, the mechanical energy is reconverted into electrical energy using another type of circuit configured to directly convert the mechanical motion into electrical power or otherwise couple energy from the magnetic field generated by the moving magnets. A load such as 910 may be connected across the coil 905. This load appears as a mechanical torque dampening the system and lowering the Q factor of the magneto-mechanical oscillator. In addition, when magnetic elements are oscillating and thus generating a strong alternating magnetic field component and if the magnetic elements are electrically conducting, eddy currents in the magnetic elements will occur. These eddy currents will also contribute to system losses.

In general, some eddy currents may be also produced by the alternating magnetic field that results from the current in the coupling coil. Smaller magnetic elements in the magneto-mechanical system may reduce eddy current effects. According to an implementation, an array of smaller magnetic elements is used in order to minimize this loss effect.

A magneto-mechanical system will exhibit saturation if the angular displacement of the magnetic element reaches a peak value. This peak value may be determined from the direction and intensity of the external H field or by the presence of a displacement stopper such as 915 to protect the torsion spring against plastic deformation. This may also be limited by the packaging, such as the limited available space for a magnetic element to rotate within. Electric breaking by modifying the electric loading may be considered an alternative method to control saturation and thus prevent damaging the magneto-mechanical system.

According to one implementation and assuming a loosely coupled regime (e.g., weak coupling, such as in the case of energy harvesting from an external magnetic field generated by a large loop antenna surrounding a large space), optimum matching may be obtained when the loaded Q becomes half of the unloaded Q. According to an implementation, the induction coil is designed to fulfill that condition to maximize the amount of output power. If coupling between transmitter and receiver is stronger (e.g., a tightly coupled regime), optimum matching may utilize a loaded Q that is significantly smaller than the unloaded Q.

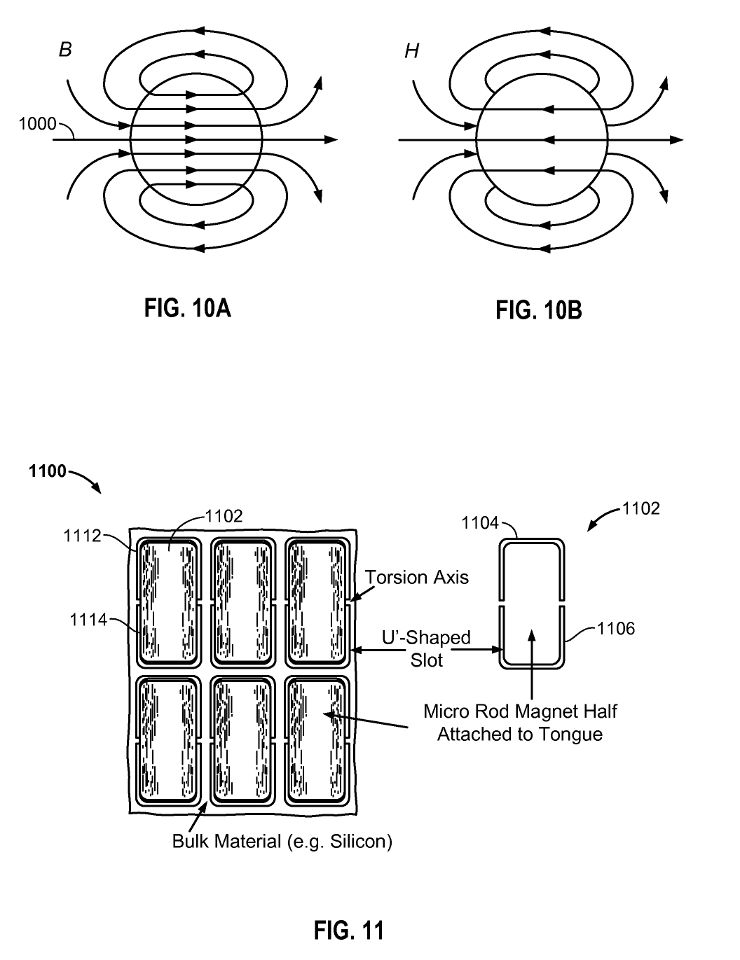

When using an array of such moving magnets, there may be mutual coupling between the magnetic elements forming the array. This mutual coupling can cause internal forces and demagnetization. According to an implementation, the array of magnetic elements may be radially symmetrical, e.g., spheroids, either regular or prolate, as shown in FIGS. 10A and 10B. FIG. 10A shows the parallel field lines of the magnetic flux density in a magnetized sphere. FIG. 10B shows the corresponding magnetic field strength (H) in a magnetized sphere. From these figures that may be seen that there may be virtually zero displacement forces between magnetic elements in a spheroid shaped three-dimensional array.

Therefore, the magnetic elements are preferably in-line with an axis 1000 of the spheroid or the disc. This causes the internal forces to vanish for angular displacement of the magnets. This causes the resonance frequency to be solely defined by the mechanical system parameters. A sphere has these advantageous factors, but may also have a demagnetization factor is low as ⅓, where an optimum demagnetization factor is one. Assuming equal orientation of axes in all directions, a disc shaped array can also be used. A disc-shaped 3D array may also result in low displacement forces, if the disc radius is much larger than its thickness and if the magnetic elements are appropriately oriented and suspended. Discs may have a higher magnetization factor, for example closer to 1.

Magnetization factor of a disc will depend on the width to diameter ratio. A disc-shaped array may be packaged into a form factor that is more suitable for integration into a device, since spheroids do not have a flat part that may be easily used without increasing the thickness of the host device.

In addition, theoretical analysis of wireless energy transfer based on magneto-mechanical systems shows that within a first order approximation and in a weakly coupled regime, the energy transfer efficiency increases proportionally to the Q-factor and to the square of the magnetization, and is inversely proportional to the density of the inertial moment. In addition, the maximum transferable power, which is limited by saturation effects, increases proportionally to the frequency, to the square of the product of the magnetic moments, and to the peak angular displacement of the magnets.

Certain implementation use micro-electromechanical systems (MEMS) to create the magneto-mechanical systems. It may be desirable to utilize magneto-mechanical metamaterials. The metamaterial may have a high total magnetic moment per volume (i.e., a high remanence of the permanent magnetic material, a high packing density described by the volume fraction of magnetic material or fill factor). Remanence may also be called “remanent magnetization” and is the magnetization left behind in a ferromagnetic material after an external magnetic field is removed. Elementary oscillators should have a small size in order to minimize a moment of inertia per volume. The metamaterial should have low losses (i.e., the elementary oscillators should have a high unloaded Q, e.g., 500+, depending upon the operating conditions of the system. The displacement angles of the elementary oscillator magnetic elements should be relatively large, e.g., preferably more than ±10° in either direction. The metamaterial should be designed to achieve a resonance frequency in the Hz to MHz range. The metamaterial should have sufficient mechanical stability to be durable and processable and should exhibit relatively low fatigue of mechanical elements to increase mean life time. The metamaterial should be manufacturable utilizing a cost effective process. However, some of these preferences may be contradictory. For example, a desired spring constant of the oscillators may be limited by the size of the oscillator and materials of its construction (e.g., soft springs cannot be made arbitrarily small and still retain functionality and suitable lifetimes). Also, greater displacement angles of the oscillators may adversely affect possible fill factors due to the greater range of motion and need for space to accommodate the same.

FIG. 11 schematically illustrates an example array of magneto-mechanical oscillators, in accordance with some exemplary implementations. An array 1100 may be formed of a number of magnetic elements such as 1102. Each magnetic element 1102 is formed of two U-shaped slots 1112, 1114 that are micro-machined or etched into a silicon substrate. A permanent rod magnetic element 1104, 1106 of similar size is formed within the slots. As a non-limiting example, the magnetic element may be 10 μm or smaller. However in other cases the size may be in the range of millimeters. At the micrometer level, crystalline materials may behave differently than larger sizes. Hence, this system can provide considerable angular displacement e.g. as high as 10° or more and extremely high Q factors. Other configurations, in accordance with some exemplary implementations can instead utilize other structures (e.g., torsional springs), in other positions and/or in other orientations, which couple the magneto-mechanical oscillators to the surrounding material.

These devices may be formed in a single bulk material such as silicon. FIG. 11 shows an example structure, in accordance with some exemplary implementations. In an example configuration, the magnetic elements 1102 shown in FIG. 11 may be fabricated in a two-dimensional structure in a common plane (e.g., a portion of a planar silicon wafer, shown in FIG. 11 in a top view, oriented parallel to the plane of the page) and such two-dimensional structures may be assembled together to form a three-dimensional structure. However, the example structure shown in FIG. 11 should not be interpreted as only being in a two-dimensional wafer structure. In other example configurations, different sub-sets of the magnetic elements 1102 may be fabricated in separate structures that are assembled together to form a three-dimensional structure (e.g., the three top magnetic elements 1102, shown in FIG. 11 in a side view, may be fabricated in a portion of one silicon wafer oriented perpendicularly to the plane of the page and the three bottom magnetic elements 1102, shown in FIG. 11 in a side view, may be fabricated in a portion of another silicon wafer oriented perpendicularly to the plane of the page).

The magnetic elements 1104, 1106 can have a high magnetization, e.g., higher than 1 Tesla. In some exemplary implementations, the magnetic element itself may be composed of two half pieces, one piece attached to the upper side and the other piece attached to the lower side. These devices may be mounted so that the center of gravity coincides with the rotational axes. The device may be covered with a low friction material, or may have a vacuum located in the area between the tongue and bulk material in order to reduce type the friction.

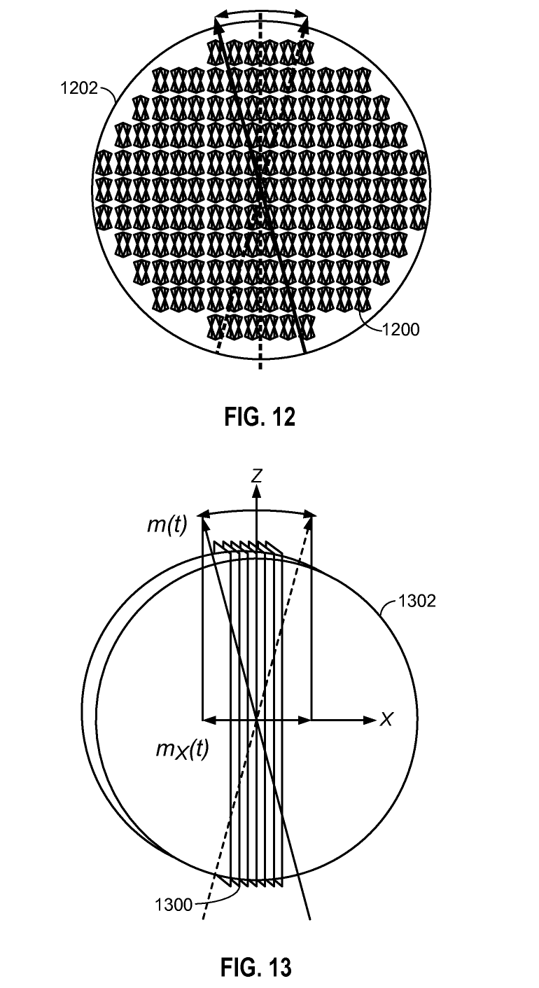

FIG. 12 schematically illustrates a cut through area of a three-dimensional array of magneto-mechanical oscillators 1200, in accordance with some exemplary implementations. While the example structure shown in FIG. 12 could be in a single two-dimensional wafer structure oriented parallel to the page, FIG. 12 should not be interpreted as only being in a two-dimensional wafer structure. For example, the three-dimensional array 1202 through which FIG. 12 shows a two-dimensional cut can comprise a plurality of planar wafer portions oriented perpendicularly to the page such that the cross-sectional view of FIG. 12 includes side views of magneto-mechanical oscillators 1200 from multiple such planar wafer portions. In one implementation, the array 1202 itself is formed of a radial symmetric shape, such as disc shaped. The disc shaped array 1202 of FIG. 12 may provide a virtually constant demagnetization factor at virtually all displacement angles. In this implementation, an induction coil may be wound around the disc to pick up the dynamic component of the oscillating induction field generated by the magneto-mechanical system. The resulting dynamic component of the system may be expressed as

mₓ(t)=|m|·sin θ(t)·eₓ

FIG. 13 schematically illustrates an example induction coil 1300 wound around a disk 1302 having a plurality of magneto-mechanical oscillators, in accordance with some exemplary implementations.

The implementations described and particularly below may be incorporated into either transmitters or receiver devices. While the description below discloses various features of a power transmitter or a power receiver, many of these same concepts and structures of the power transmitter or receiver may be used in a power receiver or transmitter as well, in accordance with some exemplary implementations. Furthermore, a power transfer system comprising at least one power transmitter and at least one power receiver can have one or both of the at least one power transmitter and the at least one power receiver having a structure as described herein.

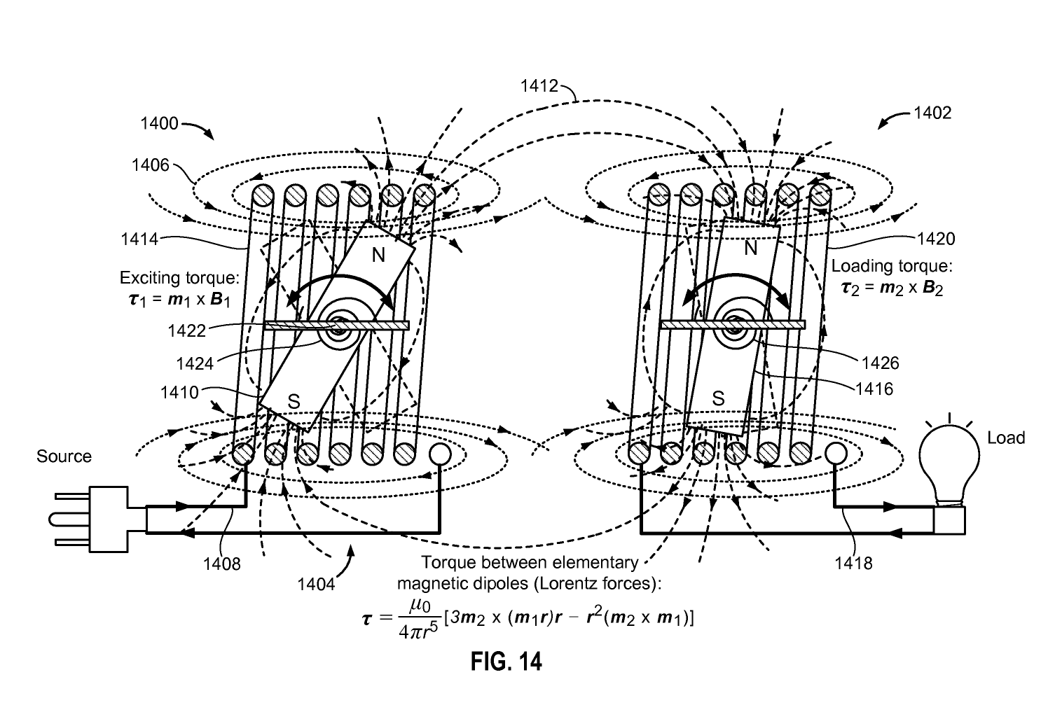

FIG. 14 schematically illustrates an example power transmitter 1400 configured to wirelessly transfer power to at least one power receiver 1402, in accordance with some exemplary implementations. The power transmitter 1400 comprises at least one excitation circuit 1404 configured to generate a time-varying (e.g., alternating) magnetic field 1406 in response to a time-varying (e.g., alternating) electric current 1408 flowing through the at least one excitation circuit 1404. The time-varying magnetic field 1406 has an excitation frequency. The power transmitter 1400 further comprises a plurality of magneto-mechanical oscillators 1410 (e.g., that are mechanically coupled to at least one substrate, which is not shown in FIG. 14). FIG. 14 schematically illustrates one example magneto-mechanical oscillator 1410 compatible with certain implementations described herein for simplicity, rather than showing the plurality of magneto-mechanical oscillators 1410. Each magneto-mechanical oscillator 1410 of the plurality of magneto-mechanical oscillators has a mechanical resonant frequency substantially equal to the excitation frequency. The plurality of magneto-mechanical oscillators 1410 is configured to generate a time-varying (e.g., alternating) magnetic field 1412 in response to movement of the plurality of magneto-mechanical oscillators 1410 under the influence of the first magnetic field 1406.

As schematically illustrated by FIG. 14, the at least one excitation circuit 1404 comprises at least one coil 1414 surrounding (e.g., encircling) at least a portion of the plurality of magneto-mechanical oscillators 1410. The at least one coil 1414 has a time-varying (e.g., alternating) current 1408 I₁(t) flowing through the at least one coil 1414, and generates a time-varying (e.g., alternating) first magnetic field 1406 which applies a torque (labeled as “exciting torque” in FIG. 14) to the magneto-mechanical oscillators 1410. Although the coil 1414 is shown, the present application is not so limited and other types of excitation circuits capable of generating a time varying magnetic field for inducing motion of the oscillators. In response to the first time-varying magnetic field 1406, the magneto-mechanical oscillators 1410 rotate about an axis. In this way, the at least one excitation circuit 1404 and the plurality of magneto-mechanical oscillators 1410 convert electrical energy into mechanical energy. The magneto-mechanical oscillators 1410 generate a second magnetic field 1412 which wirelessly transmits power to the power receiver 1402 (e.g., a power receiver as described above). For example, the power receiver 1402 can comprise a receiving plurality of magneto-mechanical oscillators 1416 configured to rotate in response to a torque applied by the second magnetic field 1412 and to induce a current 1418 in a pick-up coil 1420 (e.g., a power extraction circuit), thereby converting mechanical energy into electrical energy. Although the pick-up coil 1420 is shown, the present application is not so limited and any power extraction circuit configured to convert the mechanical energy into electrical energy for powering a load is also contemplated.

As schematically illustrated by FIG. 14 for a pick-up coil for a power transmitter utilizing a plurality of magneto-mechanical oscillators, the at least one coil 1414 of the power transmitter 1400 can comprise a single common coil that is wound around at least a portion of the plurality of magneto-mechanical oscillators 1410 of the power transmitter 1400. The wires of the at least one coil 1414 may be oriented substantially perpendicular to the “dynamic” component (described in more detail below) of the magnetic moment of the plurality of magneto-mechanical oscillators 1410 to advantageously improve (e.g., maximize) coupling between the at least one coil 1414 and the plurality of magneto-mechanical oscillators 1410. As described more fully below, the excitation current flowing through the at least one coil 1414 may be significantly lower than those used in other resonant induction systems. Thus, certain implementations described herein advantageously do not have special requirements for the design of the at least one coil 1414.

As described above with regard to FIG. 11 for the magneto-mechanical oscillators of a power receiver, the magneto-mechanical oscillators 1410 of the power transmitter 1400, in accordance with some exemplary implementations may be structures fabricated on at least one substrate (e.g., a semiconductor substrate, a silicon wafer) using lithographic processes such as are known from such fabrication techniques. Each magneto-mechanical oscillator 1410 of the plurality of magneto-mechanical oscillators 1410 can comprise a movable magnetic element configured to rotate about an axis 1422 in response to a torque applied to the movable magnetic element by the first magnetic field 1406. The movable magnetic element may comprise at least one spring 1424 (e.g., torsion spring, compression spring, extension spring) mechanically coupled to the substrate and configured to apply a restoring force to the movable magnetic element in response to rotation of the movable magnetic element. The magneto-mechanical oscillators 1416 of the power receiver 1402 can comprise a movable magnetic element (e.g., magnetic dipole) comprising at least one spring 1426 (e.g., torsion spring, compression spring, extension spring) mechanically coupled to a substrate of the power receiver 1402 and configured to apply a restoring force to the movable magnetic element in response to rotation of the movable magnetic element.

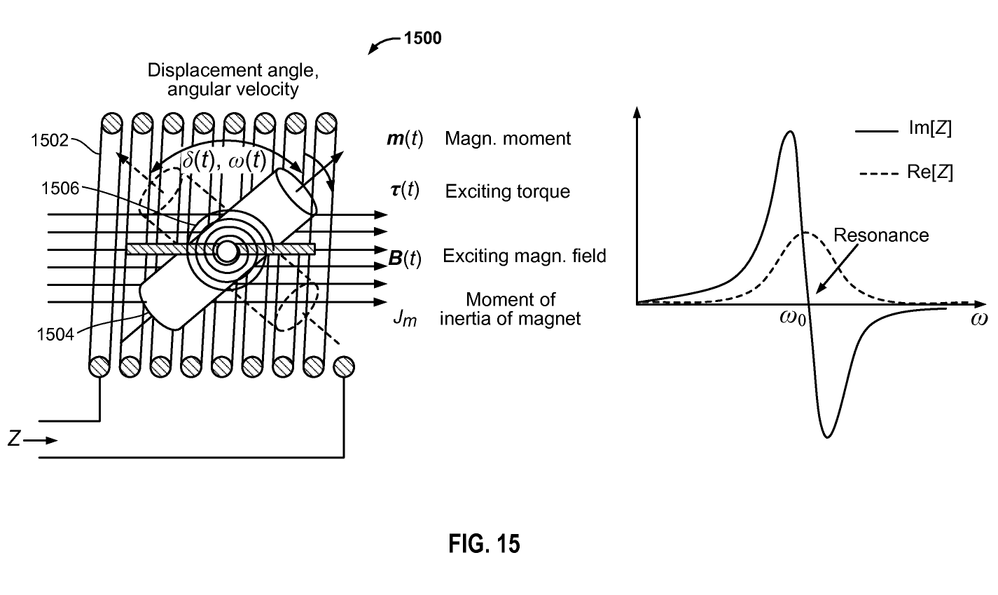

FIG. 15 schematically illustrates an example power transmitter 1500, in accordance with some exemplary implementations in which the at least one excitation circuit 1502 is driven at a frequency substantially equal to a mechanical resonant frequency of the magneto-mechanical oscillators 1504. The at least one excitation circuit 1502 generates the first magnetic field which applies the exciting torque to the magneto-mechanical oscillator 1504, which has a magnetic moment and a moment of inertia. The direction of the magnetic moment is time-varying, but its magnitude is constant. The resonant frequency of a magneto-mechanical oscillator 1504 is determined by the mechanical properties of the magneto-mechanical oscillator 1504, including its moment of inertia (a function of its size and dimensions) and spring constants.

The input impedance of the at least one excitation circuit 1502 has a real component and an imaginary component, both of which vary as a function of frequency. Near the resonant frequency of the magneto-mechanical oscillators 1504, the real component is at a maximum, and the imaginary component disappears (e.g., is substantially equal to zero) (e.g., the current and voltage of the at least one excitation circuit 1502 are in phase with one another). At this frequency, the impedance, as seen at the terminals of the at least one coil, appears as purely resistive, even though a strong alternating magnetic field may be generated by the magneto-mechanical oscillators. The combination of the at least one excitation circuit 1502 and the plurality of magneto-mechanical oscillators 1504 can appear as an “inductance-less inductor” which advantageously avoids (e.g., eliminates) the need for resonance-tuning capacitors as are used in other power transmitters.

Since the time-varying (e.g., alternating) second magnetic field is generated by the plurality of magneto-mechanical oscillators 1504, there are no high currents flowing through the electrical conductors of the at least one excitation circuit 1502 at resonance, such as exist in other resonant induction systems. Therefore, losses in the at least one excitation circuit 1502 (e.g., the exciter coil) may be negligible. In certain such configurations, thin wire or standard wire may be used in the at least one excitation circuit 1502, rather than Litz wire. The main losses occur in the plurality of magneto-mechanical oscillators 1504 and its surroundings due to mechanical friction, air resistance, eddy currents, and radiation in general. The magneto-mechanical oscillators 1504 can have Q-factors which largely exceed those of electrical resonators, particularly in the kHz and MHz ranges of frequencies. For example, the Q-factor of the plurality of magneto-mechanical oscillators 1504 (either in use for a transmitter system or a receiver system) may be greater than 500, or even greater than 10,000. Such high Q-factors may be more difficult to achieve in other resonant induction systems using capacitively loaded wire loops in some cases.

The large Q-factor of certain implementations described herein can also be provided by the plurality of magneto-mechanical oscillators 1504. The power that may be wirelessly transmitted to a load is the product of the root-mean-square (RMS) values of the torque τ_{RMS} applied to the magneto-mechanical oscillator 1504 and the frequency (e.g., angular velocity) ω_{RMS}. To allow for sufficient oscillation (e.g., sufficient angular displacement of the magneto-mechanical oscillator 1504) when power transfer distances increase, the torque τ_{RMS} (e.g., the dampening torque applied to the magneto-mechanical oscillator 1504 of a power transmitter 1500, or the loading torque applied to the magneto-mechanical oscillator of a power receiver) may be reduced, but such increased distances result in lower power. This power loss may be compensated for by increasing the frequency ω_{RMS}, within the limits given by the moment of inertia of the magneto-mechanical oscillators 1504 and the torsion springs 1506. The performance of the magneto-mechanical oscillator 1504 may be expressed as a function of the gyromagnetic ratio

$$γ = \frac{m}{{J}_{m}}$$

(where m is the magnetic moment of the magneto-mechanical oscillator 1504, and Jₘ is the moment of inertia of the magneto-mechanical oscillator 1504), and this ratio can advantageously be configured to be sufficiently high to produce sufficient performance at higher frequencies.

A plurality of small, individually oscillating magneto-mechanical oscillators arranged in a regular three-dimensional array can advantageously be used in a transmitter or receiver, instead of a single permanent magnetic element. The plurality of magneto-mechanical oscillators can have a larger gyromagnetic ratio than a single permanent magnetic element having the same total volume and mass as the plurality of magneto-mechanical oscillators. The gyromagnetic ratio of a three-dimensional array of N magneto-mechanical oscillators with a sum magnetic moment m and a sum mass Mₘ may be expressed as:

$$γ ( N ) = \frac{12 \cdot N \cdot \frac{m}{N}}{\frac{{NM}_{m}}{N} {( \frac{{l}_{m}}{\sqrt[3]{N}} )}^{2}} = \frac{12 m}{{M}_{m} {l}_{m}^{2}} {\sqrt[3]{N}}^{2}$$

where lₘ denotes the length of an equivalent single magnetic element (N=1).

This equation shows that the gyromagnetic ratio increases to the power of ⅔ with decreasing size of the magneto-mechanical oscillators. In other words, a large magnetic moment produced by an array of small magneto-mechanical oscillators may be accelerated and set into oscillation by a faint torque (e.g., the exciting torque produced by a small excitation current flowing through the at least one excitation current of a power transmitter or the loading torque in a power receiver produced by a distant power transmitter). The performance of the plurality of magneto-mechanical oscillators may be increased by increasing the number of magneto-mechanical oscillators since the magnetic moment increases more than does the moment of inertia by increasing the number of magneto-mechanical oscillators.

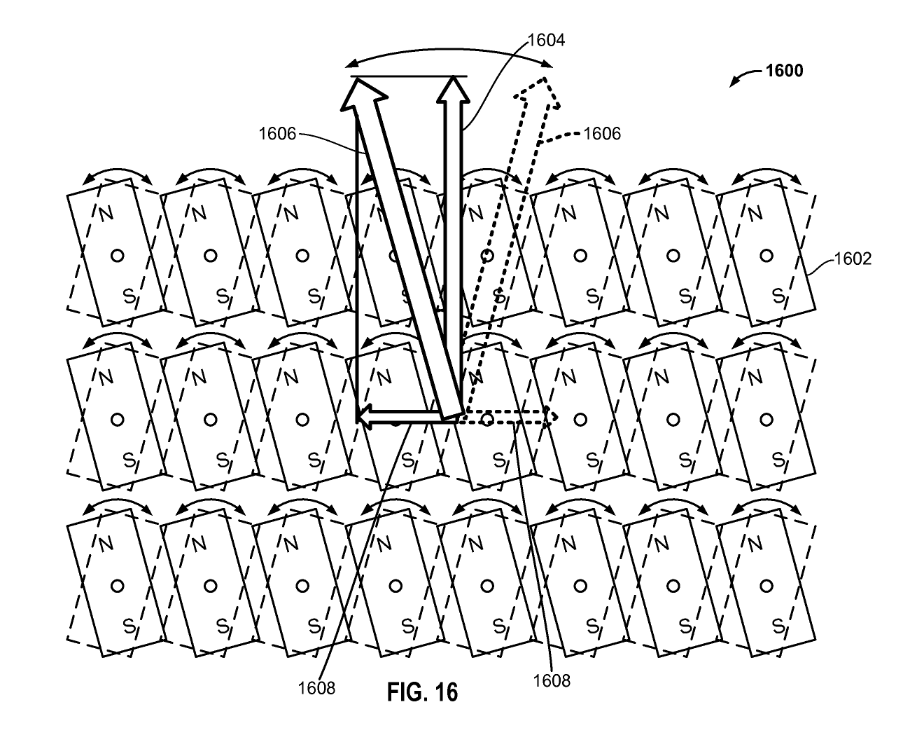

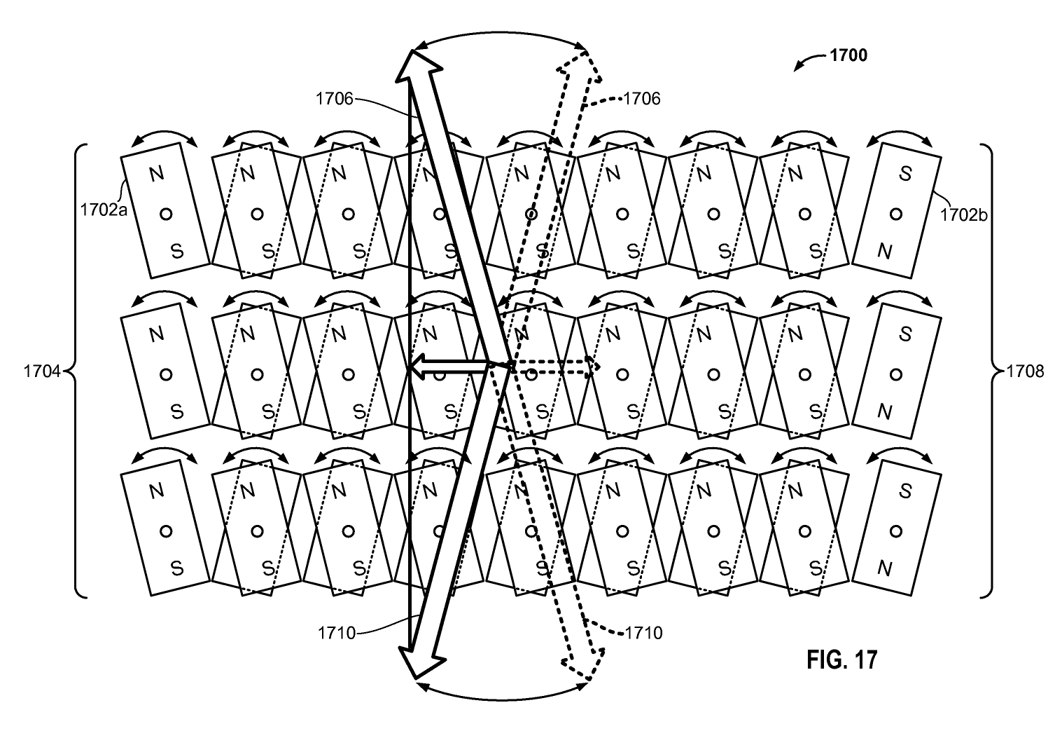

FIG. 16 schematically illustrates an example portion 1600 of a configuration of a plurality of magneto-mechanical oscillators 1602, in accordance with some exemplary implementations. The portion 1600 shown in FIG. 16 comprises a set of magneto-mechanical oscillators 1602. This arrangement of magneto-mechanical oscillators 1602 in a regular structure is similar to that of a plane in an atomic lattice structure (e.g., a three-dimensional crystal).

The oscillation of the magneto-mechanical oscillators 1602 between the solid positions and the dashed positions produces a sum magnetic moment that may be decomposed into a “quasi-static” component 1604 (denoted in FIG. 16 by the vertical solid arrow) and a “dynamic” component 1606 (denoted in FIG. 16 by the solid and dashed arrows at an angle to the vertical, and having a horizontal component 1608 shown by solid and dashed arrows). The dynamic component 1606 is responsible for energy transfer. For an example configuration such as shown in FIG. 16, for a maximum angular displacement of 30 degrees, a volume utilization factor of 20% for the set of magneto-mechanical oscillators 1602, a rare-earth metal magnetic material having 1.6 Tesla at its surface, a “dynamic” flux density in the order of 160 milli-Tesla peak may be achieved virtually without hysteresis losses, thereby outperforming certain other ferrite technologies.

However, the quasi-static component 1604 may be of no value in the energy transfer. In fact, in practical applications, it may be desirable to avoid (e.g., lessen or eliminate) the quasi-static component 1604, since it results in a strong magnetization (e.g., such as that of a strong permanent magnet) that can attract any magnetic materials in the vicinity of the structure towards the plurality of magneto-mechanical oscillators 1602.

The sum magnetic field generated by the plurality of magneto-mechanical oscillators 1602 can cause the individual magneto-mechanical oscillators 1602 to experience a torque such that they rest at a non-zero displacement angle. These forces may also change the effective torsion spring constant, thus modifying the resonant frequency. These forces may be controlled (e.g., avoided, reduced, or eliminated) by selecting the macroscopic shape of the array of the plurality of magneto-mechanical oscillators 1602 to be rotationally symmetric (e.g., a disk-shaped array). For example, using an array that is radially symmetrical (e.g., spheroidal, either regular or prolate, as shown in FIGS. 10A, 10B, and 12) can produce effectively zero displacement between the magneto-mechanical oscillators 1602 in a spheroid-shaped three-dimensional array. The field lines of some magnetic field components inside a magnetized disk are parallel for any orientation of the magnetic moment, and in a disk-shaped array, resonant frequencies may be determined mainly by the moment of inertia and the torsional spring constant of the magneto-mechanical oscillators.

FIG. 17 schematically illustrates an example configuration in which the plurality of magneto-mechanical oscillators 1702a and 1702b is arranged in a three-dimensional array 1700 in which the quasi-static components of various portions of the plurality of magneto-mechanical oscillators 1702 cancel one another, in accordance with some exemplary implementations. The three-dimensional array 1700 of FIG. 17 comprises at least one first plane 1704 (e.g., a first layer) comprising a first set of magneto-mechanical oscillators 1702a of the plurality of magneto-mechanical oscillators 1702, with each magneto-mechanical oscillator 1702a of the first set of magneto-mechanical oscillators 1702a having a magnetic moment pointing in a first direction. The first set of magneto-mechanical oscillators 1702a has a first summed magnetic moment 1706 (denoted in FIG. 17 by the top solid and dashed arrows) comprising a time-varying component and a time-invariant component. The three-dimensional array 1700 further comprises at least one second plane 1708 (e.g., a second layer) comprising a second set of magneto-mechanical oscillators 1702b of the plurality of magneto-mechanical oscillators 1702. Each magneto-mechanical oscillator 1702b of the second set of magneto-mechanical oscillators 1702b has a magnetic moment pointing in a second direction. The second set of magneto-mechanical oscillators 1702b has a second summed magnetic moment 1710 (denoted in FIG. 17 by the bottom solid and dashed arrows) comprising a time-varying component and a time-invariant component. The time-invariant component of the first summed magnetic moment 1706 and the time-invariant component of the second summed magnetic moment 1710 have substantially equal magnitudes as one another and point in substantially opposite directions as one another. In this way, the quasi-static components of the magnetic moments of the first set of magneto-mechanical oscillators 1702a and the second set of magneto-mechanical oscillators 1702b cancel one another out (e.g., by having the polarities of the magneto-mechanical oscillators alternate between adjacent planes of a three-dimensional array 1700). In contrast, the time-varying components of the first summed magnetic moment 1706 and the second summed magnetic moment 1710 have substantially equal magnitudes as one another and point in substantially the same direction as one another.

The structure of FIG. 17 is analogous to the structure of paramagnetic materials that have magnetic properties (e.g., a relative permeability greater than one) but that cannot be magnetized (e.g., soft ferrites). Such an array configuration may be advantageous, but can produce a counter-torque acting against the torque produced by an external magnetic field on the magneto-mechanical oscillators. This counter-torque will be generally added to the torque of the torsion spring. This counter-torque may be used as a restoring force to supplement that of the torsion spring or to be used in the absence of a torsion spring in the magneto-mechanical oscillator. In addition, the counter-torque may reduce the degrees of freedom in configuring the plurality of magneto-mechanical oscillators.

Some of the aforementioned implementations include a coil (or multiple coils) surrounding the magneto-mechanical oscillators in a receiver to convert an external magnetic field provided by a transmitter to mechanical energy (e.g., from the oscillation of the magneto-mechanical oscillators) and the mechanical energy to electrical energy (e.g., by the inducement of current in the coil) that can be used to power a load. However, the coils may occupy a significant amount of space, increasing the size of the receiver used to power the load. Additionally, if the coil surrounds multiple magneto-mechanical oscillators with alternating magnetic moments, then the extraction of the mechanical energy to electrical energy may be difficult or inefficient. Accordingly, implementing a wireless transmission system into a small space, such as a mobile device, may be difficult.

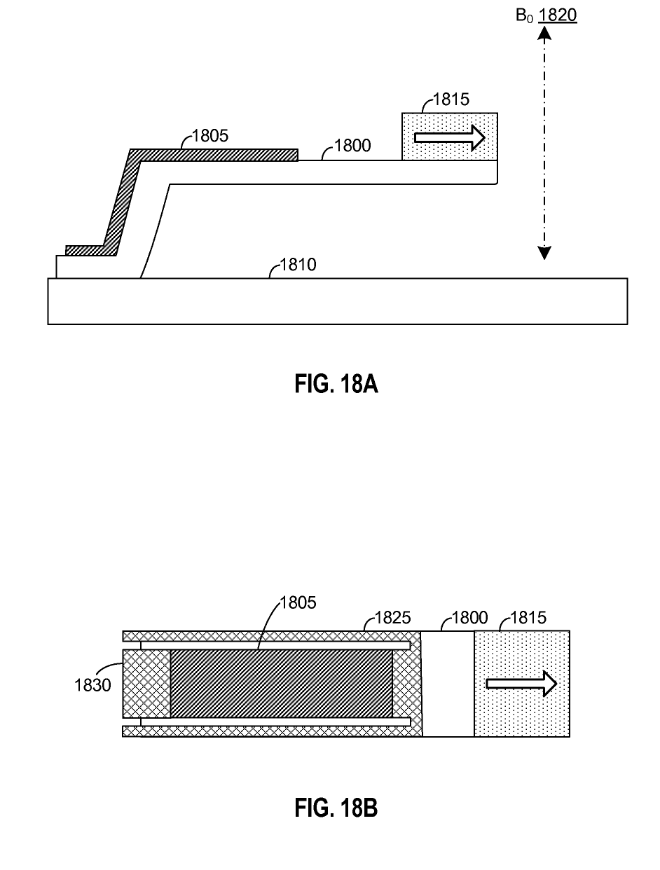

FIG. 18A illustrates a cantilever including piezoelectric material and magnetic material, in accordance with some implementations. Cantilever 1800 in FIG. 18A may be a magneto-mechanical oscillator that is a part of a receiver of a wireless charging system that generates current to power a load in response to an external magnetic field generated by a transmitter of the wireless charging system. Piezoelectric material 1805 positioned or affixed to the cantilever 1800 may be used to generate the current to power the load. Accordingly, the system of FIG. 18A implements a transducer to convert a magnetic field to mechanical energy and the mechanical energy to electrical energy.

Cantilever 1800 may be an electromechanical system (EMS) including electrical and mechanical elements and manufactured at a variety of scales including, but not limited to, microscales and nanoscales. For example, cantilever 1800 may be a microelectromechanical system (MEMS) device having elements in sizes ranging from about a micron to hundreds of microns or more, a nanoelectromechanical systems (NEMS) device having elements in sizes smaller than a micron including, for example, sizes smaller than several hundred nanometers. Cantilever 1800 and its related elements may be created using deposition, etching, lithography, and/or other micromachining processes that etch away parts of substrates and/or deposited material layers, or that add layers to form electrical and electromechanical devices. Additionally, cantilever 1800 may be larger in size than MEMS or NEMS. For example, it may be of a size in the millimeters that allows for assembly by hand or non-micromachining techniques.

In FIG. 18A, cantilever 1800 may be a structure affixed to substrate 1810 such that one end of cantilever 1800 may be affixed (e.g., anchored) to substrate 1810 and another end is not affixed to substrate 1810 (e.g., floating above substrate 1810). Magnetic material 1815 may be a deposit of magnetic material (i.e., cantilever 1800 may include a magnetic material portion), such as a NiFeB thin film or other type of magnetic material arranged to be a load supported by cantilever 1800. Piezoelectric material 1805 may be a deposit of Lead Zirconate Titantate (PZT), aluminum nitride, zinc oxide, or other type of material providing a piezoelectric effect (i.e., a material that may accumulate electrical charge in response to an applied mechanical stress) on a high-stress area of cantilever 1800 (i.e., cantilever 1800 may include a piezoelectric material portion). In some implementations, piezoelectric material 1805 may be placed on a portion of cantilever 1800 that undergoes a high amount strain such as the hinge area anchored to substrate 1810 of cantilever 1800.

In effect, a voltage may be generated across piezoelectric material 1805 when deformed or strained (e.g., when displaced due to being stretched or contracted), and therefore, charge and/or current may be generated and used to power a load. In particular, magnetic material 1815 may move in response to magnetic field 1820, which may be an alternating or oscillating external magnetic field generated by a transceiver. Accordingly, as the external magnetic field oscillates, magnetic material 1815 may react to it, moving down (e.g., towards or depressing into the cavity or free space beneath cantilever 1800 and above substrate 1810) and moving up on cantilever 1800 (e.g., away from substrate 1810). As a result, magnetic material 1815 causes cantilever 1800 to be moved down or up (i.e., flex) based on magnetic field 1820 (based on its direction and strength) and piezoelectric material 1805 may be deformed as cantilever 1800 flexes, and therefore, generate charge that can be used to power a load.

In FIG. 18A, magnetic field 1820 is oriented perpendicular to the surface of substrate 1810. That is, magnetic field may alternate directions between being oriented towards substrate 1810 and away from substrate 1810 (i.e., magnetic field 1820 may be an oscillating magnetic field). As a result, the end of cantilever 1800 with magnetic material 1815 also may oscillate (i.e., pushed towards or pulled away from substrate 1810) in response to the oscillation of magnetic field 1820.

Generally, an increase in torque applied to cantilever 1800 may increase the strain used to deform piezoelectric material 1805. The torque can be conceptualized as the cross-product of the direction of magnetic field 1820 and the magnetic orientation (i.e., pointing from its south pole to north pole) of magnetic material 1815. Accordingly, in some implementations, magnetic material 1815 may have a magnetic orientation perpendicular to magnetic field 1820 to increase the torque used to oscillate cantilever 1800. Additionally, in some implementations, cantilever 1800 may oscillate at a resonant frequency that is the same or similar to the frequency of magnetic field 1820. For example the mechanical arrangement of the cantilever 1800 with the magnetic material 1815 may be configured to be resonant (e.g., species of a mechanical resonator) at a particular frequency of an applied magnetic field such that it tends to have larger oscillations at that frequency as compared to other frequencies.

Magnetic material 1815 may have a magnetic orientation directed away from piezoelectric material 1805 and parallel to substrate 1810 as indicated by the arrow to increase the torque on cantilever 1800, and therefore, increase the deformation that piezoelectric material 1805 undergoes. In other words, the magnetic orientation of magnetic material 1815 may be “in-plane” with substrate 1810 (i.e., the surface it is integrated upon) and perpendicular to magnetic field 1820 (i.e., the external magnetic field generated by a transmitter).

FIG. 18B illustrates a top-down perspective of the cantilever of FIG. 18A, in accordance with some implementations. In FIG. 18B, terminals 1825 and 1830 may be electrical contacts coupled with piezoelectric material 1805. A voltage generated across piezoelectric material 1805 as it is strained (i.e., when cantilever 1800 flexes due to magnetic material 1815 reacting to magnetic field 1820) also may generate a voltage difference between terminals 1825 and 1830, providing a power supply that may be used to power a load.

In some implementations, terminals 1825 and 1830 may cover larger portions or be placed in other geometric positions in relation to piezoelectric material 1805. For example, terminal 1825 may cover a top part of piezoelectric material 1805 (e.g., the entire top side of piezoelectric material 1805, or a part of it) and terminal 1830 may cover a bottom part of piezoelectric material 1805 (e.g., the entire bottom size of piezoelectric material 1805, or a part of it such that terminal 1830 is between piezoelectric material 1805 and cantilever 1800).

In some implementations, a coil may surround cantilever 1800 to also induce current to provide an additional source to power a load. That is, piezoelectric material 1805 and a coil may both be used to generate electrical energy from mechanical energy generated from the reaction of magnetic material 1815 to magnetic field 1820.

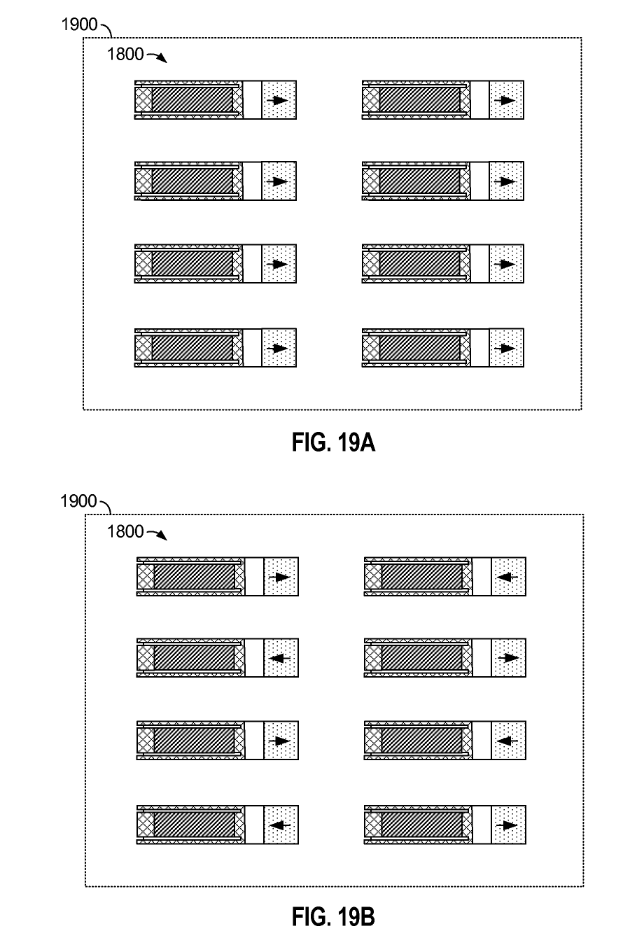

In some implementations, an array may include a plurality of cantilevers 1800 to power a load. FIG. 19A illustrates an array of cantilevers with uniform magnetic orientations, in accordance with some implementations. In FIG. 19A, array 1900 includes multiple cantilevers 1800. Each of the cantilevers 1800 in array 1900 in FIG. 19A has the same magnetic orientation for their corresponding magnetic material 1815. That is, each of the magnetic loads of the cantilevers 1800 have a generally uniform magnetization, and therefore, each cantilever 1800 in array 1900 may react similarly to magnetic field 1820.

For example, when magnetic field 1820 is pointing in a first direction, each cantilever 1800 in array 1900 may move in the same direction. When magnetic field 1820 oscillates to point in a second direction, each cantilever 1800 in array 1900 may also oscillate and point in the same direction (e.g., the opposite direction as before). Accordingly, the cantilevers 1800 in array 1900 in FIG. 19A may be canted in the same direction at the same time in response to magnetic field 1820 (i.e., tilted or oriented in away or towards substrate 1810).

However, the implementation of FIG. 19A may generate a strong magnet since each of the magnetic loads 1815 have a magnetic orientation in the same direction. As a result, magnetic objects may be attracted towards array 1900.

FIG. 19B illustrates an array of cantilevers with non-uniform magnetic orientations (i.e., different orientations), in accordance with some implementations. The array of cantilevers in FIG. 19B may cancel each others' magnetization out, and therefore, decrease the static magnetic field of array 1900, reducing the likelihood of objects being attracted towards array 1900 in FIG. 19B.

For example, in FIG. 19B, array 1900 also includes multiple cantilevers 1800. However, by contrast to FIG. 19A, cantilevers 1800 in array 1900 in FIG. 19B have non-uniform magnetic orientations for the corresponding magnetic material 1815. That is, the magnetic material 1815 of cantilevers 1800 in array 1900 of FIG. 19B may have different magnetic orientations. For example, in FIG. 19B, two different directions (i.e., left-to-right and right-to-left) for the magnetic orientations are shown in a “checkerboard” type pattern alternating between the two different directions. However, other implementations may include different patterns (e.g., alternating magnetic orientations in row-by-row, column-by-column, etc.) or more directions (e.g., more than two different magnetic orientations).

As previously discussed, in FIG. 19B, array 1900 includes two different groups of cantilevers 1800. A first group of cantilevers 1800 may have a magnetic orientation pointing from left-to-right. A second group of cantilevers 1800 may have a magnetic orientation pointing from right-to-left. Since the magnetic orientations between the two groups are different, each group may react differently to magnetic field 1820. For example, when magnetic field 1820 is pointing in a first direction, the cantilevers in the first group may move in an opposite direction as the cantilevers in the second group (i.e., the cantilevers 1800 may operate out of phase with each other). When magnetic field 1820 oscillates to point in a second direction, the cantilevers in the first group may then move to the position that the second group was previously in, and the second group may move to the position that the first group was previously in. Accordingly, the cantilevers 1800 in the different groups may be canted in different directions at the same time in response to magnetic field 1820 (i.e., tilted or oriented in different directions away or towards substrate 1810).

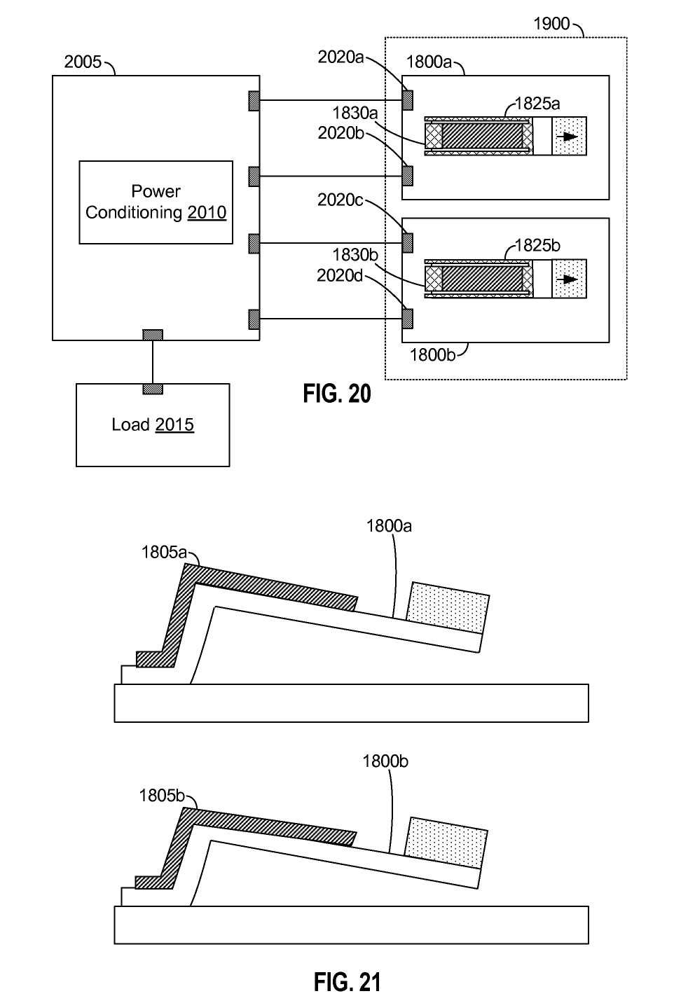

FIG. 20 schematically illustrates power extraction circuitry coupled with cantilevers to power a load, in accordance with some implementations. In FIG. 20, power extraction circuitry 2005 may be coupled with cantilevers 1800a and 1800b of array 1900 to provide a power supply from array 1900 to load 2015 for the implementation of a receiver of a wireless charging system.

Outputs 2020a-d may be coupled with terminals 1825 and 1830 of the corresponding cantilever 1800. For example, output 2020a may be coupled with terminal 1825 of cantilever 1800a and output 2020b may be coupled with terminal 1825 of cantilever 1800a. Accordingly, the voltage difference between outputs 2020a and 2020b may be based on the voltage difference across piezoelectric material 1805a. Likewise, output 2020c may be coupled with terminal 1825 of cantilever 1800b and output 2020d may be coupled with terminal 1830 of cantilever 1800b. Each of outputs 2020a-d may be provided as an input to power extraction circuitry 2005 so that array 1900 may be used as a power supply for load 2010. In particular, as voltage is generated across piezoelectric material 1805 as cantilever 1800 is flexed from the reaction of magnetic material 1815 to an oscillating magnetic field 1820, the electrical charge accumulated within piezoelectric material 1805 may be used as a power supply for load 2015.

In some implementations, power extraction circuitry 2005 in FIG. 20 may include power conditioning circuitry 2010. Power conditioning circuitry 2010 may “combine” the outputs from each individual piezoelectric material 1805 of each cantilever 1800 in array 1900 to provide a power supply. In particular, each piezoelectric material 1805 may be modeled as a current source providing a driving current based on (e.g., proportional to) the mechanical stress upon the hinge area of cantilever 1805. Accordingly, the current, or charge, can be combined and, if needed, rectified, to provide a power supply for load 2010.

For example, power conditioning circuitry 2010 may implement a rectifier circuit to convert alternating current (AC) to direct current (DC) to provide a DC power source for load 2010. Such functionality may be useful because array 1900 may be conceptualized as an AC power supply since cantilevers 1800a and 1800b oscillate up-and-down, switching the polarities of the voltage across piezoelectric material 1805.

As another example, when magnetic field 1820 causes cantilevers 1800a and 1800b to oscillate towards substrate 1810, a 0.1 to 30 V potential difference may exist between terminals 1825 and 1830. For example, cantilevers 1800a and 1800b may oscillate to generate 8 V. However, when magnetic field 1820 alternates in direction (due to it being oscillating), cantilevers 1800 and 1800b may oscillate away from substrate 1810 resulting in a switch in polarity of the voltage, and therefore, a −8 V potential difference may exist between terminals 1825 and 1830. Power conditioning circuitry 2010 also may rectify the voltages such that voltages of a single polarity (e.g., positive polarity) are provided to load 2015.

In some implementations, if array 1900 in FIG. 20 includes non-uniform magnetic orientations (e.g., similar to FIG. 19B), then the voltages generated across the terminals 1825 and 1830 of cantilevers 1800 in different groups also may be different. For example, magnetic field 1820 may be oriented in a direction such that a first group of cantilevers 1800 are canted in a first direction and a second group of cantilevers 1800 are canted in a second direction because the magnetic orientations of the magnetic material of the cantilevers are different. As a result, the corresponding magnetic materials 1805 are strained differently, and therefore, the voltage difference from terminal 1825 to terminal 1830 in the first group of cantilevers 1800 may be 8 V, but the voltage difference from terminal 1825 to terminal 1830 in the second group of cantilevers 1800 may be −8 V (i.e., the two different groups may provide voltages of different polarities at the same time). Accordingly, power conditioning circuitry 2010 also may provide rectification for this implementation.

In some implementations, process variations may cause individual cantilevers 1800 to respond slightly differently to magnetic field 1820. For example, magnetic orientation, magnetic strength, thickness, and other characteristics of magnetic material 1805, piezoelectric material 1805, cantilever 1800, and substrate 1810 may vary across array 1900. FIG. 21 illustrates two cantilevers responding differently to a magnetic field, in accordance with some implementations. In FIG. 21, both cantilevers 1800a and 1800b may have magnetic materials 1805 with a uniform magnetic orientation. Accordingly, both may move in similar directions in response to the oscillation of magnetic field 1820.

However, as shown in FIG. 21, the movement of cantilevers 1800a and 1800b may not be synchronized. For example, in FIG. 21, cantilever 1800b may move more (i.e., move closer to substrate 1810) than cantilever 1800a, creating a different amount of strain upon the corresponding piezoelectric materials 1805a and 1805b, and therefore, a different voltage difference may be generated across piezoelectric material 1805a and piezoelectric material 1805b. This may be the result of cantilevers 1800a and 1800b oscillating at different resonant frequencies in response to the magnetic field. In some implementations, having cantilevers 1800a and 1800b capable of oscillating at the same or similar resonant frequency may be desirable.

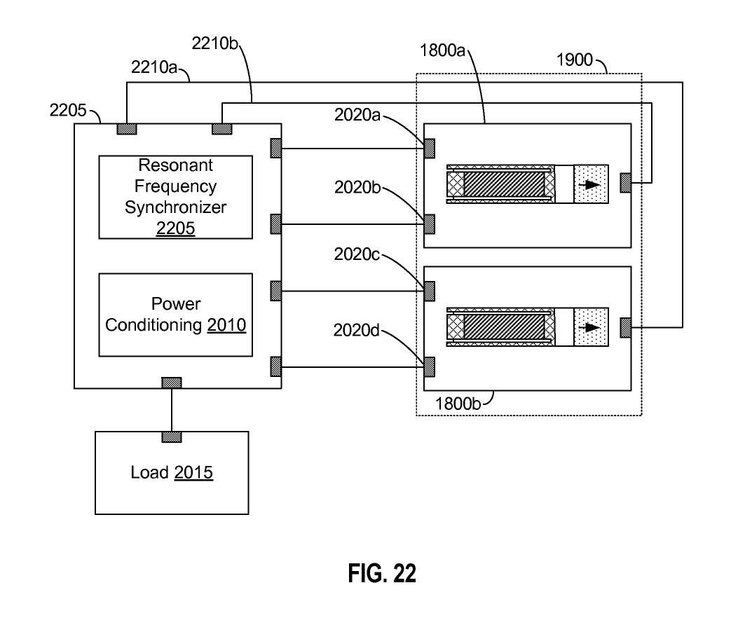

FIG. 22 schematically illustrates power extraction circuitry to adjust a resonant frequency of cantilevers, in accordance with some implementations. In FIG. 22, power extraction circuitry 2005 includes resonant frequency synchronizer 2205 to adjust the resonant frequency of one or more cantilevers 1800 by generating a signal applied to piezoelectric material 1805.

As previously discussed, piezoelectric material 1805 of cantilever 1800 may accumulate charge (and generate a voltage across piezoelectric material 1805) in response to an applied strain due to magnetic material 1815 causing cantilever 1800 to flex in response to magnetic field 1820. Conversely, a voltage may be applied across piezoelectric material 1805, generating an applied electric field across piezoelectric material 1805, and strain may be internally generated within piezoelectric material 1805 based on the applied voltage and electric field. Accordingly, applying a voltage across piezoelectric material 1805 may result in an adjustment of mechanical characteristics of cantilever 1800, including how much cantilever 1800 may cant (or tilt), for example, by stretching or contracting piezoelectric material 1805 and adjusting its rigidity. For example, if piezoelectric material 1805 is more rigid, then cantilever 1800 may not cant as much as if piezoelectric material is less rigid. As a result, a signal or voltages may be applied to piezoelectric material 1805b of cantilever 1800b in FIG. 21 to adjust the resonant frequency of the oscillation of cantilever 1800b such that it may be the same or similar to the resonant frequency of the oscillation of cantilever 1800a.

In FIG. 22, resonant frequency synchronizer 2205 of power extraction circuitry 2005 may determine electrical characteristics of cantilevers 1800a and 1800b (e.g., voltage, charge, or currents corresponding to one or more of outputs 2020a-d) and adjust mechanical characteristics of one or more of cantilevers 1800a and 1800b. For example, if the electrical characteristics of cantilever 1800a indicate that the resonant frequency of its oscillation is different than the resonant frequency of the oscillation of cantilever 1800b (based on a comparison of the electrical characteristics showing a difference between cantilevers 1800a and 1800b), then a signal 2210b (e.g., a voltage) may be generated by resonant frequency synchronizer 2205 and applied to cantilever 1800a. The signal may provide an appropriate voltage to be applied to piezoelectric material 1805a of cantilever 1800a such that enough mechanical strain may be induced such that cantilever 1800a may have a resonant frequency similar to cantilever 1800b. In some implementations, cantilever 1800a may be provided two signals to be applied individually at different portions of piezoelectric material 1805a to generate a sufficient electric field to induce an appropriate strain within piezoelectric material 1805 to adjust the resonant frequency of cantilever 1800. As a result, a voltage may be applied across piezoelectric material 1805 to adjust the resonant frequency of cantilever 1800. In some implementations, the voltage can be applied across cantilever 1800 and substrate 1810. Additionally, the resonant frequency of each cantilever 1800 in the array may be set such that they are all resonant together at the resonant frequency of magnetic field 1820 that is to be applied to the entire array.

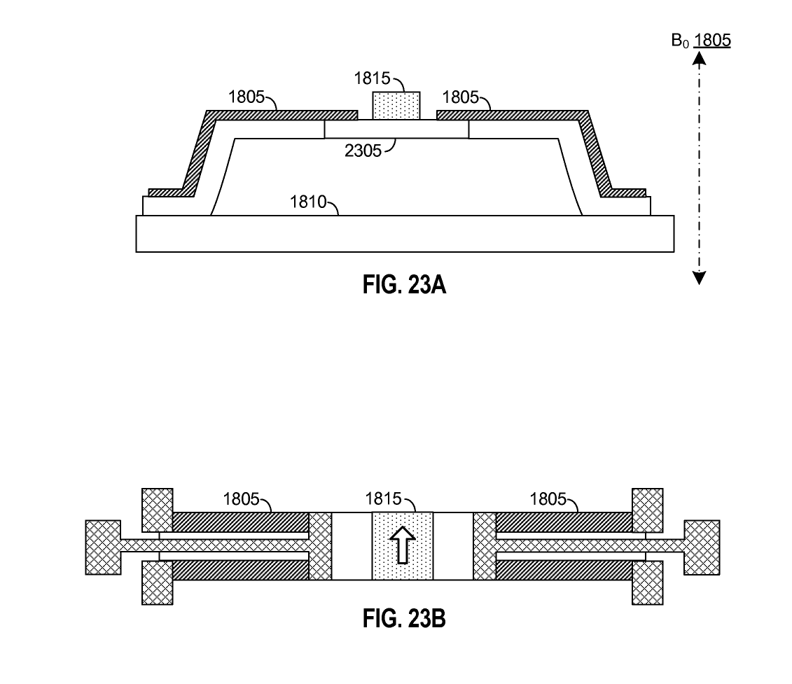

Though the above examples use cantilevers to deform a deposit of piezoelectric material 1805, in other implementations, other types of structures may be used. FIG. 23A illustrates a beam including piezoelectric material and magnetic material, in accordance with some implementations. In FIG. 23A, magnetic material 1815 may be placed on beam 2305 that can be deformed by the reaction of magnetic material 1815 to magnetic field 1805, resulting in deformation of piezoelectric material 1805, similar to the implementation of FIG. 18A. For example, the interaction of magnetic material 1815 with magnetic field 1805 in FIG. 23A may cause beam 2305 to oscillate up-and-down (i.e., away and towards substrate 1810).

FIG. 23B illustrates a top-down perspective of the cantilever of FIG. 23A, in accordance with some exemplary implementations. In FIG. 23B, the two different piezoelectric material deposits may have separate sets of terminals because two different deposits of piezoelectric material 1805 are arranged upon beam 2305. Similar to the implementation of FIG. 18A, the magnetic orientation of magnetic material 1815 on beam 2305 also may be in a direction to increase the torque applied to beam 2305. That is, the magnetic orientation of magnetic material 1815 may be “in-plane” with substrate 1810 (i.e., the surface it is integrated upon) and perpendicular to magnetic field 1820 (i.e., the external magnetic field generated by a transmitter, such as a transmitter that is a separate device from the receiver of a wireless power transfer system).

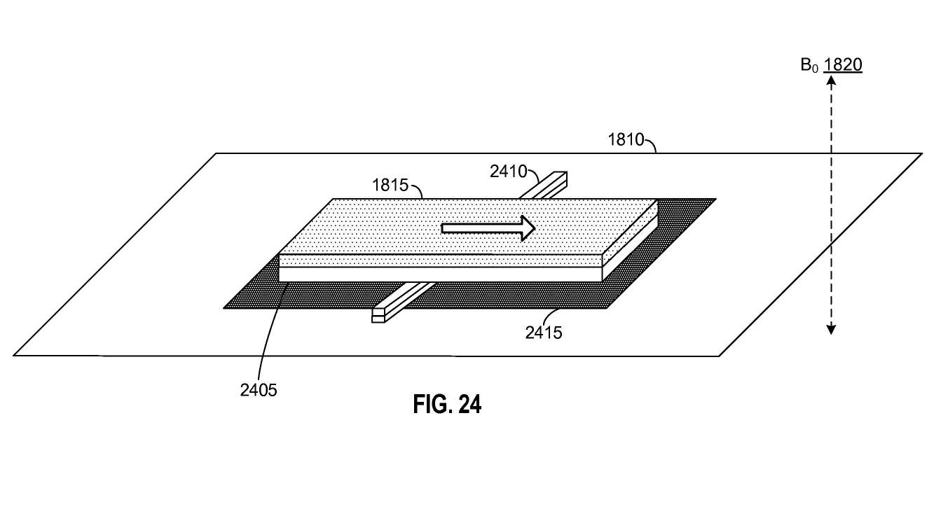

FIG. 24 illustrates a torsional plate including piezoelectric material and a magnetic load, in accordance with some exemplary implementations. Torsional plate 2405 in FIG. 24 also may be a type of structure used in the implementations described herein. In FIG. 24, torsional plate 2405 includes magnetic material 1815 and hinges 2410. Piezoelectric material may be deposited upon hinges 2410 such that they may be strained as torsional plate 2405 deforms into and out of cavity 2415 as magnetic material 1815 responds to magnetic field 1820. In some implementations, cavity 2415 may be a portion of substrate 1810 that is etched to form free space for torsional plate 2405 to deform into. Allowing torsional plate 2405 to deform into cavity 2415 may allow for more deformation of the piezoelectric material because it may increase the range of motion of torsional plate 2415 because the bottom surface of cavity 2415 may be beneath the top surface of substrate 1810. Similar cavities also may be utilized with the implementations of FIGS. 18A and 23A.

The cantilever of FIG. 18A and the torsional hinge of FIG. 24 deform or rotate around a point outside of magnetic material 1815. Moreover, the aforementioned structures are constrained from deforming or rotating in any direction. This may reduce the amount of charge generated by piezoelectric material 1805 if magnetic field 1820 is not perpendicular with respect to the magnetic orientation of magnetic material 1815. For example, the amount of torque applied to cantilever 1800 may be lower than if magnetic field 1820 is perpendicular with respect to the magnetic orientation of magnetic material 1815, resulting in a reduction in the strain used to deform piezoelectric material 1805.

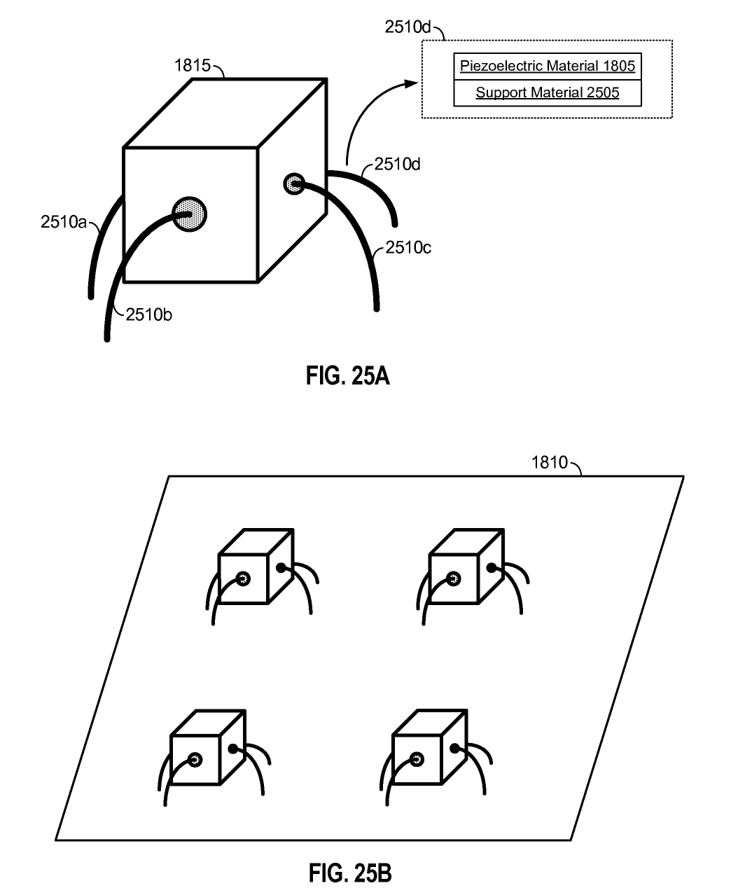

FIG. 25A illustrates a magnetic structure with a center of rotation within the magnetic structure, in accordance with some exemplary implementations. For example, the center of rotation may be the center of magnetic material 1815 in FIG. 25A. Magnetic material 1815 in FIG. 25A can move in any direction, and therefore, the torque applied from the interaction of magnetic field 1820 (in many orientations) with magnetic material 1815 in FIG. 25A can be higher, resulting in more strain on piezoelectric material 1805 and more charge to be generated by piezoelectric material 1805.

In FIG. 25A, magnetic material 1815 is shown as a cube, but the shape may be different in other implementations (e.g., round, rectangular, etc.). In FIG. 25A, magnetic material 1815 may be suspended over a substrate and able to move along any direction in response to applied external magnetic field 1820. Magnetic material 1815 in FIG. 25A can be a MEMS or NEMS device, or a device at a larger scale, for example 0.5-2 millimeters cubed. Hinges 2510a-2510d can be hinges used to support magnetic material 1815 and anchored onto a substrate. Hinges 2510a-2510d can include a layer of piezoelectric material 1805 along with a support material 2505 (e.g., a dielectric material) to provide some structural rigidity to suspend magnetic material 1815 over the substrate. Hinges 2510a-d can be on the order of 1 mm long and 400 micrometers wide. Accordingly, as magnetic material 1815 moves, hinges 2510a-d may also move, straining piezoelectric material 1805.

The techniques described herein, for example the techniques described with FIGS. 19A-22, can also be applied to the implementation of FIG. 25A. For example, FIG. 25B illustrates an array of magnetic structures with center of rotations within the magnetic structures, in accordance with some implementations. The array of FIG. 25B can be placed on substrate 1810 and have uniform or non-uniform magnetic orientations. Additionally, power extraction circuitry 2005 can be coupled with the structures of the array, similar to FIGS. 20-22.

The implementations of FIGS. 25A and 25B can generate sufficient charge even if magnetic field 1820 is at a low frequency. For example, if magnetic material 1815 in FIG. 25A is a larger size (e.g., 1 mm³), then an externally applied magnetic field having a frequency of less than 1 megahertz (MHz) can generate a proper amount of torque on magnetic material 1815 to strain piezoelectric material 1805 to power a load. In another example, with a 1 mm³ magnetic structure, and a magnetic field oscillating at less than 1 kilohertz, power in the tens to hundreds of microwatts range can be generated. Additionally, a lower quality factor Q (i.e., an indication of the rate of energy loss relative to energy stored in a resonator such as the oscillating structures described herein) can also be used. For example, a Q of 100 for the structures of FIGS. 25A and 25B can generate enough power for a load in several applications, including biomedical devices (e.g., devices implanted within or on a human body) and devices and sensors such as those used in the Internet of Things. In other wireless power applications, Q is often much higher (e.g., in the hundreds or thousands). For example, via use of piezoelectric materials it may be at least partially advantageous to prevent the magnets from rotating freely (e.g., dampen the oscillation—e.g., lowering Q in some respects) to extract additional power or to increase power transfer for a particular range of frequencies (e.g., 10 to 1 KHz) with magnetics with largish hinges for implementing a piezo stack).

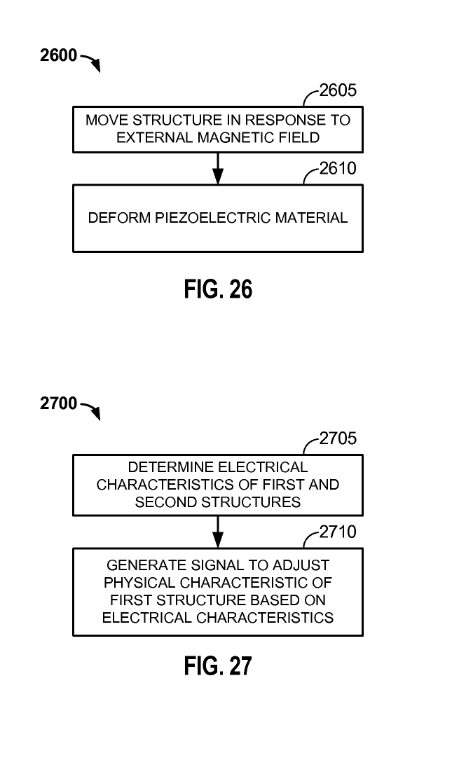

FIG. 26 is a flowchart of a method of using a receiver of a wireless charging system, in accordance with some exemplary implementations. In method 2600, at block 2605, a structure may move in response to an external magnetic field. For example magnetic material on the structure may respond to the external magnetic field, pushing or pulling upon the structure it is affixed to. At block 2610, piezoelectric material may be deformed in response to the movement of the structure. For example, a deposit of piezoelectric material on the structure may be strained as the structure moves, and therefore, charge may be accumulated within the piezoelectric material.

FIG. 27 is a flowchart of a method of using an array of structures including piezoelectric material as a power supply, in accordance with some exemplary implementations. In method 2700, at block 2705, electrical characteristics of a first and a second structure may be determined. For example, voltage, current, charge, or other electrical characteristic provided by cantilevers 1800 in array 1900 may be provided to power extraction circuitry 2005. At block 2710, a signal may be generated to adjust a physical characteristic of the first structure based on the electrical characteristics of the first and second structures. For example, a voltage may be applied by power extraction circuitry 2005 to piezoelectric material 1805 of the first structure to adjust the resonant frequency of the corresponding cantilever 1800.

In certain implementations, the wirelessly transferred power is used for wirelessly charging an electronic device (e.g., wirelessly charging a mobile electronic device). In certain implementations, the wirelessly transferred power is used for wirelessly charging an energy-storage device (e.g., a battery) configured to power an electric device (e.g., an electric vehicle).

The various operations of methods described above may be performed by any suitable means capable of performing the operations, such as various hardware and/or software component(s), circuits, and/or module(s). Generally, any operations illustrated in the figures may be performed by corresponding functional means capable of performing the operations. For example, a power transmitter or receiver can comprise means for generating a second time-varying magnetic field having an excitation frequency by applying a first time-varying magnetic field having the excitation frequency to the means for generating the second time-varying magnetic field. The means for generating the second time-varying magnetic field can comprise a plurality of magneto-mechanical oscillators in which each magneto-mechanical oscillator of the plurality of magneto-mechanical oscillators has a mechanical resonant frequency substantially equal to the excitation frequency and is configured to generate the second magnetic field via movement of the oscillators under the influence of the first magnetic field.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and algorithm steps described in connection with the implementations disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality may be implemented in varying ways for each particular application, but such implementation decisions should not be interpreted as causing a departure from the scope of the implementations of the invention.

The various illustrative blocks, modules, and circuits described in connection with the implementations disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm and functions described in connection with the implementations disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art. A storage medium is coupled to the processor such that the processor can read information from, and write information to, the storage medium. In the alternative, the storage medium may be integral to the processor. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer readable media. The processor and the storage medium may reside in an ASIC.

For purposes of summarizing the disclosure, certain aspects, advantages and novel features of the inventions have been described herein. It is to be understood that not necessarily all such advantages may be achieved in accordance with any particular implementation of the invention. Thus, the invention may be embodied or carried out in a manner that achieves or optimizes one advantage or group of advantages as taught herein without necessarily achieving other advantages as may be taught or suggested herein.

Various modifications of the above described implementations will be readily apparent, and the generic principles defined herein may be applied to other implementations without departing from the spirit or scope of the invention. Thus, the present invention is not intended to be limited to the implementations shown herein but is to be accorded the widest scope consistent with the principles and novel features disclosed herein.

What is claimed is:

1. An apparatus for wireless power transfer comprising:
an array of structures, each of the structures comprising a piezoelectric material portion and a magnetic material portion, each of the magnetic material portions capable of responding to an alternating magnetic field generated by an external transmitter device to oscillate the corresponding structures and strain the corresponding piezoelectric material portions to generate electrical current.

2. The apparatus of claim 1, wherein the array includes a first structure including a first magnetic material portion and a second structure including a second magnetic material portion, the first magnetic material portion and the second magnetic material portion having a same magnetic orientation.

3. The apparatus of claim 1, wherein the array includes a first structure including a first magnetic material portion having a first magnetic orientation and a second structure including a second magnetic material portion having a second magnetic orientation, the first magnetic orientation and the second magnetic orientation being different orientations.

4. The apparatus of claim 3, wherein the first structure and the second structure are capable of oscillating at different phases.

5. The apparatus of claim 1, wherein the array of structures includes a first structure having the magnetic material portion positioned at a location on the first structure capable of depressing into free space beneath the first structure based on the magnetic material portion reacting to the alternating magnetic field.

6. The apparatus of claim 5, wherein the first structure is affixed to a substrate, the substrate defines a cavity underneath the magnetic material portion of the first structure, and wherein a bottom surface of the cavity is beneath a top surface of the substrate.

7. The apparatus of claim 1, wherein the array of structures includes a first structure having a plate affixed with the magnetic material portion, and the plate is capable of being deformed into a cavity of a substrate beneath the plate.

8. The apparatus of claim 7, wherein the plate of the first structure is anchored on one or more hinges of the first structure, the one or more hinges including the piezoelectric material portions.

9. The apparatus of claim 1, further comprising:
power extraction circuitry capable of receiving the generated electrical current from each of the structures of the array.

10. The apparatus of claim 9, wherein the power extraction circuitry is further capable of rectifying the generated electrical currents from each of the structures of the array and providing a direct current (DC) power source to a load.

11. The apparatus of claim 9, wherein the power extraction circuitry is further capable of adjusting a resonant frequency of the oscillation of one or more of the structures.

12. The apparatus of claim 11, wherein the power extraction circuitry is further capable of adjusting the resonant frequency of the one or more of the structures by generating a voltage to be applied to the piezoelectric material portions of one or more of the structures.

13. The apparatus of claim 12, wherein rigidities of the piezoelectric material portions are adjusted based on the voltage applied to the piezoelectric material portions of the one or more of the structures.

14. The apparatus of claim 1, wherein magnetic orientations of the magnetic material portions of the structures are substantially parallel to a substrate that the structures are affixed to.

15. The apparatus of claim 1, wherein each of the structures are capable of oscillating to a resonant frequency that is substantially the same as a frequency of the alternating magnetic field.

16. The apparatus of claim 1, wherein each of the structures is a mechanically resonant structure configured to oscillate at a resonant frequency.

17. A system for wireless power transfer comprising:
a first structure having a first piezoelectric material deposit and a first magnetic material deposit;
a second structure having a second piezoelectric material deposit and a second magnetic material deposit, wherein the first and second magnetic material deposits are capable of responding to an alternating magnetic field generated by an external transmitter device to oscillate the corresponding structures and strain the corresponding piezoelectric material deposits to generate electrical current; and
power circuitry capable of receiving the electrical current from the first structure and the second structure, and further capable of providing a power supply based on the received electrical current.

18. The system of claim 17, wherein the first magnetic material deposit and the second magnetic material deposit have a same magnetic orientation.

19. The system of claim 17, wherein the first magnetic material deposit has a first magnetic orientation and the second magnetic material deposit has a second magnetic orientation, the first magnetic orientation and the second magnetic orientation being different orientations.

20. A method for wireless power transfer comprising:
oscillating structures in an array of structures in response to an alternating magnetic field, each of the structures oscillating based on a response of a corresponding magnetic material of the structures to the alternating magnetic field; and
deforming a piezoelectric material on the structures of the array to generate electrical current.

21. The method of claim 20, further comprising:
adjusting a resonant frequency of the oscillation of a first structure in the array in response to the generated electrical current of a second structure in the array.

22. An array of structures for wireless power transfer, each of the structures comprising:
means for responding to an alternating magnetic field to generate mechanical energy;
means for converting the mechanical energy to electrical energy.

23. The array of structures of claim 22, wherein the alternating magnetic field is generated by an external transmitter device.

24. The array of structures of claim 23, wherein each of the structures oscillates in response to the alternating magnetic field.

25. The array of structures of claim 22, further comprising:
means for adjusting a resonant frequency of oscillation of one or more of the structures of the array.

26. The array of structures of claim 22, wherein the means for converting the mechanical energy to electrical energy comprises:
means for generating electrical currents from each of the structures.

27. The array of structures of claim 26, further comprising:
means for rectifying the electrical currents generated from each of the structures of the array.

28. The array of structures of claim 27, further comprising:
means for providing a direct current (DC) power source using the rectified electrical currents to power a load.

29. The array of structures of claim 22, wherein the array includes a first structure including a first magnetic material portion having a first magnetic orientation and a second structure including a second magnetic material portion having a second magnetic orientation, the first magnetic orientation and the second magnetic orientation being different orientations.

30. The array of structures of claim 29, wherein the first structure and the second structure are capable of oscillating at different phases.
